(19) United States
(12) Patent Application Publication
(10) Pub. No.: US 2011/0144850 A1
(43) Pub. Date: Jun. 16, 2011

(54) MOVING APPARATUS, MOVING METHOD OF MOVING APPARATUS, AND MOVEMENT CONTROL PROGRAM OF MOVING APPARATUS

(76) Inventor: Takashi Jikihara, Tokyo (JP)

(21) Appl. No.: 12/812,773

(22) PCT Filed: Dec. 4, 2008
(86) PCT No.: PCT/JP2008/072086

§ 371 Date: Jul. 14, 2010

(30) Foreign Application Priority Data
Jan. 16, 2008 (JP) 2008-007090

(51) Int. Cl. G05D 1/02

(52) U.S. Cl. 701/26

(57) ABSTRACT

A moving apparatus includes a route preparing function unit, a moving function unit, an obstacle detecting function unit, an obstacle removal requesting function unit, an obstacle judging function unit, a request target detecting function unit and an obstacle selecting function unit. Here, the route preparing function unit prepares a route to a destination. The moving function unit moves along the route. The obstacle detecting function unit detects obstacles that interfere in the movement. Here, when the obstacles exist on the route, the route preparing function unit tries to prepare a different route from the route. When the different route exists, the moving function unit tries to move to the destination along the different route. The obstacle removal requesting function unit requests the outside to remove the obstacles outside the route, when the different route does not exist. The obstacle judging function unit judges existence of at least one removable obstacle that can be removed from the route among the obstacles detected by the obstacle detecting function unit. The request target detecting function unit detects at least one request capable target who is capable of being requested to remove the removable obstacle by the obstacle removal requesting function unit, in an outside. The obstacle selecting function unit, when there is a plurality of removable obstacles as the at least one removable obstacle, selectively determine a removal target obstacle that is an obstacle whose removal is requested by the obstacle removal requesting function unit from the plurality of removable obstacles.

### TECHNICAL FIELD

The present invention relates to a moving apparatus, a moving method of a moving apparatus, and a movement control program of a moving apparatus.

### BACKGROUND ART

A technique that a moving body (a moving apparatus) autonomously moves to a destination while avoiding an obstacle is known. In this technique, a large number of methods have been proposed until now. However, under a complicated environment such as a house environment or the like in which the obstacles disperse, there is a case that the obstacle blocks a route to the destination. In this way, as a problem before the obstacle is avoided, the route is blocked by the obstacle. Thus, there is a case that the moving body cannot arrive at the destination single-handedly.

For such a problem, a moving system for requesting a person around it to remove the obstacle is described in Japanese Patent Publication No. JP-P 2001-129787A. This autonomously moving system is provided with an obstacle detecting means, an obstacle judging means, a person detecting means and an obstacle removal requesting means. This autonomously moving system is operated as follows. That is, a moving body looks for an obstacle existing on a movement route by using the obstacle detecting means during the movement. Next, the moving body judges whether or not the detected obstacle can be removed by using the obstacle judging means. In succession, the moving body checks whether or not a person exists around the moving body by using the person detecting means. Then, the moving body requests the person, who exists around the moving body, to remove the obstacle by using the obstacle removal requesting means.

Also, in relation to the above, Japanese Patent Publication No. JP-A-Showa, 63-276610 discloses a running course preparing apparatus. This running course preparing apparatus includes a recognizing means, a control means, a first preparing means and a second preparing means. Here, the recognizing means recognizes position information of a target and an obstacle. The control means judges whether or not a straight route from any point to the target can be prepared on the basis of the position information of the target and the obstacle obtained by the recognizing means; and a shape of a ground projection surface of an automatic vehicle. The control means further judges whether or not at least one straight route, in which the obstacle existing in a target direction can be avoided, from any point to the target can be prepared, when the foregoing straight route cannot be prepared. Also, the first preparing means selects the obstacle to be removed from the obstacles, when the control means judges that the straight route in which the obstacle existing in the target direction can be avoided cannot prepared at all. The first preparing means prepares a running route to a point at which the obstacle to be removed is held and sets a point at which the removed obstacle is placed. Also, if the control means judges that the straight route to the target can be prepared, the second preparing means prepares a route to a target point. The second preparing means prepares the route, in which the obstacle can be avoided, if the straight route, in which the obstacle can be avoided, is judged to be preparable.

Also, Japanese Patent Publication No. JP-A-Heisei, 2-230409 discloses a working vehicle. This working vehicle carries out a predetermined work while running inside a predetermined region. This working vehicle is provided with a running means, a control means, a distance sensor and a temperature sensor. Here, the running means executes a running. The control means controls the running executed by the running means. The distance sensor measures a distance from a forward obstacle. The temperature sensor detects a temperature of the forward obstacle. The control means stops the running for a predetermined time when the distance from the obstacle detected by the distance sensor becomes a predetermined distance or less and the temperature detected by the temperature sensor is a predetermined temperature or more. When the obstacle does not move after that, the control means carries out an avoiding running.

Also, Japanese Patent Publication No. JP-A-Heisei, 9-185412 discloses an autonomously moving apparatus. This autonomously moving apparatus includes a distance sensor, an infrared sensor, a judging means and a control means. Here, the distance sensor detects an obstacle in a forward running direction. The infrared sensor can detect infrared rays emitted by a person. The judging means judges whether or not the obstacle is the person by using the infrared sensor, when the distance sensor detects the obstacle. If the obstacle is the person, the control means stops the autonomously moving apparatus and instructs it to wait for certain time. If the obstacle exists even after the elapse of the certain time, the control means instructs it to shift to an avoiding operation. If the obstacle does not exist, the control means instructs the autonomously moving apparatus to restart the running.

Also, Japanese Patent Publication No. JP-P 2000-202792A discloses a sweeping robot. This sweeping robot carries out an automatic running and a sweeping. This sweeping robot includes a front wheel, rear wheels and a safety wheel. Here, the rear wheel is larger in diameter than the front wheel. The safety wheel is arranged ahead of the front wheel and can be raised and lowered. This sweeping robot detects the size of an obstacle and judges that it cannot be moved, if the obstacle is larger than a predetermined size.

Also, Japanese Patent Publication No. JP-P 2006-277121A discloses a movement route preparing apparatus, a moving robot, a movement route preparing method and a movement route preparing program. This movement route preparing apparatus prepares a movement route used by the moving robot when the moving robot moves inside a predetermined region. This movement route preparing apparatus includes a room layout information holding means, a feature information extracting means, a movement allowance/rejection estimating means and a movement route preparing means. Here, the room layout information holding means holds room layout information indicating room layout of the predetermined region. The feature information extracting means extracts feature information that is picture information indicating a feature with regard to the movement route, from the room layout information held by the room layout information holding means. The movement allowance/rejection estimating means estimates whether or not the moving robot can move to a position corresponding to the feature information, on the basis of the feature information extracted by the feature information extracting means. The movement route preparing means prepares a movement route, on the basis of the movement allowance/rejection of the moving robot that is estimated by the movement allowance/rejection estimating means about the position corresponding to the feature information.

Also, Hart, P. E.; Nilsson, N. J.; Raphael, B. (1968). “A Formal Basis for the Heuristic Determination of Minimum Cost Paths”, IEEE Transactions on Systems Science and Cybernetics SSC9 (2): pp 100-107 discloses a so-called “A * Algorism”. This A * Algorism in the Hart document is the algorism for enabling a route preparation, for example, when position information of an obstacle is recorded as a grid-shaped map.

Also, P. Viola, M. J. Jones, “Robust Real-Time Face Detection”, International Journal of Computer Vision, Vol. 57, No. 2, May 2004, pp. 137-154, discloses a face recognizing method. The face recognizing method of this Viola document is the method that takes a face image of a person and enables the recognition of the person.

Also, Nagasawa Hiroshi (2003); “Dairy Life Action and Muscular Force”, Physical Therapy Science, Vol. 18, No. 1, pp. 7-13 discloses an age change of a body force, especially a gripping power, as a relatively average value with a value in 20 years old as 100%.

The inventor discovers the following problems, on this occasion.

The foregoing moving system does not assume a case that there is a plurality of obstacles blocking the movement route. For this reason, the foregoing moving system is required to request the removal of the obstacle, for each discovery of the obstacle. This is hard to say the effective movement strategy for the moving body.

Then, the inventor properly considers that, each time the moving body encounters the obstacle, a different route should be repeatedly prepared to try the movement. Then, when the different route does not exist, namely, when the obstacles are known to exist in all of the routes, the inventor considers that the removal of the obstacle should be requested for the first time. At this time, this inventor considers that the obstacle to be removed is required to be selected from the plurality of obstacles, on the basis of information with regard to the obstacles, information with regard to the moving body, and information with regard to the request target. However, the above various documents do not discuss the moving body, the moving method and the movement control program that carry out the foregoing selection.

Moreover, there is a possibility that the above moving system selects the large obstacle whose removal is difficult, from the plurality of obstacles, although there is the small obstacle whose removal is easy, when the erroneous selection is carried out.

### DISCLOSURE OF INVENTION

The present invention is proposed in view of the above-mentioned subjects. An object of the present invention is to provide an autonomously moving body that selects an adequate obstacle, which is a target of a removal request, from the plurality of obstacles blocking routes of the moving body, and an autonomously moving method to do so, and an autonomously movement control program.

A moving apparatus according to the present invention includes a route preparing function unit, a moving function unit, an obstacle detecting function unit, an obstacle removal requesting function unit, an obstacle judging function unit, a request target detecting function unit and an obstacle selecting function unit. Here, the route preparing function unit prepares a route to a destination. The moving function unit moves along the route. The obstacle detecting function unit detects obstacles that interfere in the movement. Here, when the obstacles exist on the route, the route preparing function unit tries to prepare a different route from the route. When the different route exists, the moving function unit tries to move to the destination along the different route. The obstacle removal requesting function unit requests the outside to remove the obstacles outside the route, when the different route does not exist. The obstacle judging function unit judges existence of at least one removable obstacle that can be removed from the route among the obstacles detected by the obstacle detecting function unit. The request target detecting function unit detects at least one request capable target who is capable of being requested to remove the removable obstacle by the obstacle removal requesting function unit, in an outside. The obstacle selecting function unit, when there is a plurality of removable obstacles as the at least one removable obstacle, selectively determine a removal target obstacle that is an obstacle whose removal is requested by the obstacle removal requesting function unit from the plurality of removable obstacles.

A moving method according to the present invention includes: (a) a route preparing step in which a route preparing function unit prepares a route to a destination; and (b) a moving step in which a moving function unit tries to move along the route. Here, the moving step (b) includes: (b-1) an obstacle detecting step in which a obstacle detecting function unit tries to detect obstacles; (b-2) a different route preparing step in which the route preparing function unit tries to prepare a different route from the route, when the obstacles exist on the route in the obstacle detecting step (b-1); (b-3) a step in which the moving function unit tries to move to the destination along the different route, when the different route exists in the different route preparing step (b-2); and (b-4) an obstacle removal requesting step in which an obstacle removal requesting function unit requests an outside to remove the obstacle outside the route, when the different route does not exist in the different route preparing step (b-2). Here, the obstacle removal requesting step (b-4) includes: (b-4-a) an obstacle judging step in which an obstacle judging function unit judges existence of at least one removable obstacle that can be removed from on the route, among the obstacles detected by the obstacle detecting function unit; (b-9-b) a request target detecting step in which a request target detecting function unit detects at least one request capable target who is capable of being requested to remove the removable obstacle, in the outside; and (b-4-c) an obstacle selecting step in which an obstacle selecting function unit, when there is a plurality of removable obstacles as the at least one removable obstacle in the obstacle judging step (b-4-a), selectively determines a removal target obstacle that is an obstacle whose removal is requested by the obstacle removal requesting function unit, from the plurality of removable obstacles.

A movement control program according to the present invention includes: (a) a route preparing step in which a route preparing function unit prepares a route to a destination; and (b) a moving step in which a moving function unit tries to move along the route. Here, the moving step (b) includes: (b-1) an obstacle detecting step in which a obstacle detecting function unit tries to detect obstacles; (b-2) a different route preparing step in which the route preparing function unit tries to prepare a different route from the route, when the obstacles exist on the route in the obstacle detecting step (b-1); (b-3) a step in which the moving function unit tries to move to the destination along the different route, when the different route exists in the different route preparing step (b-2); and (b-4) an obstacle removal requesting step in which an obstacle removal requesting function unit requests an outside to remove the obstacle outside the route, when the different route does not exist in the different route preparing step (b-2). Here, the obstacle removal requesting step (b-4) includes: (b-4-a) an obstacle judging step in which an obstacle judging function unit judges existence of at least one removable obstacle that can be removed from on the route, among the obstacles detected by the obstacle detecting function unit; (b-4-b) a request target detecting step in which a request target detecting function unit detects at least one request capable target who is capable of being requested to remove the removable obstacle, in the outside; and (b-4-c) an obstacle selecting step in which an obstacle selecting function unit, when there is a plurality of removable obstacles as the at least one removable obstacle in the obstacle judging step (b-4-a), selectively determines a removal target obstacle that is an obstacle whose removal is requested by the obstacle removal requesting function unit, from the plurality of removable obstacles.

### BRIEF DESCRIPTION OF THE DRAWINGS

The above and other objects, advantages and features of the present invention will be more apparent from the following description of certain preferred exemplary embodiments (examples) taken in conjunction with the accompanying drawings, in which:

FIG. 1 is a block diagram describing a configuration of an autonomously moving body in a first exemplary embodiment of the present invention;

FIG. 2 is a block diagram describing in detail the configuration of the autonomously moving body in the first exemplary embodiment of the present invention;

FIG. 3 is a map group describing a processing example in an obstacle judging function unit in the first exemplary embodiment of the present invention;

FIG. 4A is one part of a flowchart describing an entire operation procedure of an autonomously moving method in the first exemplary embodiment of the present invention;

FIG. 4B is the other part of the flowchart describing the entire operation procedure of the autonomously moving method in the first exemplary embodiment of the present invention;

FIG. 5 is a block diagram describing in detail a configuration of an autonomously moving body in a second exemplary embodiment of the present invention;

FIG. 6A is one part of a flowchart describing in detail an entire operation procedure of an autonomously moving method in the second exemplary embodiment of the present invention;

FIG. 6B is the other part of the flowchart describing in detail the entire operation procedure of the autonomously moving method in the second exemplary embodiment of the present invention;

FIG. 7 is a block diagram describing in detail a configuration of an autonomously moving body in a third exemplary embodiment of the present invention;

FIG. 8A is one part of a flowchart describing in detail an entire operation procedure of an autonomously moving method in the third exemplary embodiment of the present invention;

FIG. 8B is the other part of the flowchart describing in detail the entire operation procedure of the autonomously moving method in the third exemplary embodiment of the present invention;

FIG. 9 is a block diagram describing a detailed configuration of a moving body in an example of the present invention; and

FIG. 10 is a map group describing an operation example of the moving body, which indicates a manner that a space where a moving robot moves is changed, in the example of the present invention.

### BEST MODE FOR CARRYING OUT THE INVENTION

The best mode of carrying out an autonomously moving body, a moving method of the moving body, and a movement control program of the moving body according to the present invention will be described below with reference to the attached drawings.

### First Exemplary Embodiment

The first exemplary embodiment for carrying out the present invention will be described below in detail with reference to the drawings.

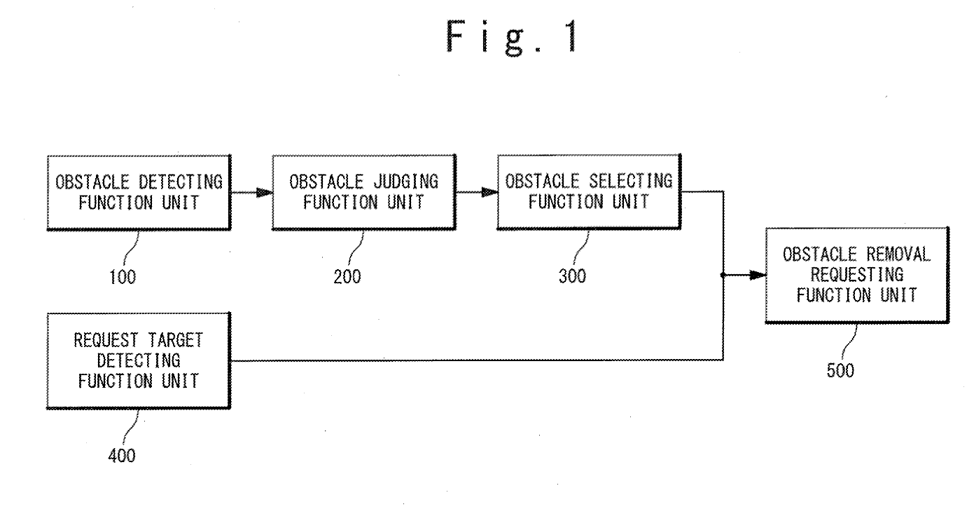

FIG. 1 is a block diagram showing a configuration of an autonomously moving body according to the first exemplary embodiment of the present invention. The autonomously moving body in this exemplary embodiment moves to a destination while avoiding an obstacle. The autonomously moving body in this exemplary embodiment includes an obstacle detecting function unit 100, an obstacle judging function unit 200, an obstacle selecting function unit 300, a request target detecting function unit 400 and an obstacle removal requesting function unit 500.

Here, the obstacle detecting function unit 100 detects an obstacle around the autonomously moving body, when the autonomously moving body carries out a movement. The obstacle detecting function unit 100 is attained by, for example, hardware for obstacle detection and an information processing apparatus such as a computer for processing information (data) from the hardware by using software (programs). The detection result of the obstacle detecting function unit 100 is sent to the obstacle judging function unit 200.

The obstacle judging function unit 200, when judging that all of the routes through which the autonomously moving body moves to a destination are blocked by obstacles, judges whether or not the obstacles detected by the obstacle detecting function unit 100 can be removed. The obstacle judging function unit 200 is attained by, for example, an information processing apparatus such as a computer for processing the information (data) from the obstacle detecting function unit 100 and the like by using software (programs). The judgment result of the obstacle judging function unit 200 is sent to the obstacle selecting function unit 300.

The obstacle selecting function unit 300 selects an obstacle to be removed if the obstacle judging function unit 200 judges that there is a removable obstacle. This selection is carried out to minimize costs, by using information with regard to the obstacle, information with regard to the moving body, or information with regard to a request target. The costs include the cost required for a request target and the cost required for the moving body. The obstacle may be selected to minimize both of these costs. The obstacle selecting function unit 300 is attained by, for example, an information processing apparatus such as a computer for processing the information (data) from the obstacle judging function unit 200 and the like by using software (programs). The selection result of the obstacle selecting function unit 300 is sent to the obstacle removal requesting function unit 500.

Also, the request target detecting function unit 400 detects a request target, when recognizing that all of the routes through which the autonomously moving body moves to the destination are blocked by the obstacles. The request target detecting function unit 400 is attained by, for example, hardware for request target detection and an information processing apparatus such as a computer for processing the information (data) from the hardware by using software (programs). The detection result of the request target detecting function unit 400 is sent to the obstacle removal requesting function unit 500.

The obstacle removal requesting function unit 500 requests the request target detected by the request target detecting function unit 400, to remove the obstacle selected by the obstacle selecting function unit 300. Here, the request target may be, for example, a person or a robot outside the moving body, or the obstacle itself. The obstacle removal requesting function unit 500 is attained, for example, by: an information processing apparatus such as a computer for processing the information (data) from the request target detecting function unit 400 and the like by using software (programs); and hardware for carrying out a obstacle removing request in response to the information (data) from the information processing apparatus.

As mentioned above, the combination of the obstacle to be removed and the request target of the removal is properly selected by using the information with regard to the obstacle, the information with regard to the moving body, or the information with regard to the request target. Thus, the autonomously moving body according to this exemplary embodiment can properly select the obstacle to be removed. Incidentally, the information processing apparatuses such as the respective computers as exemplified above may be integrated or may be partially integrated.

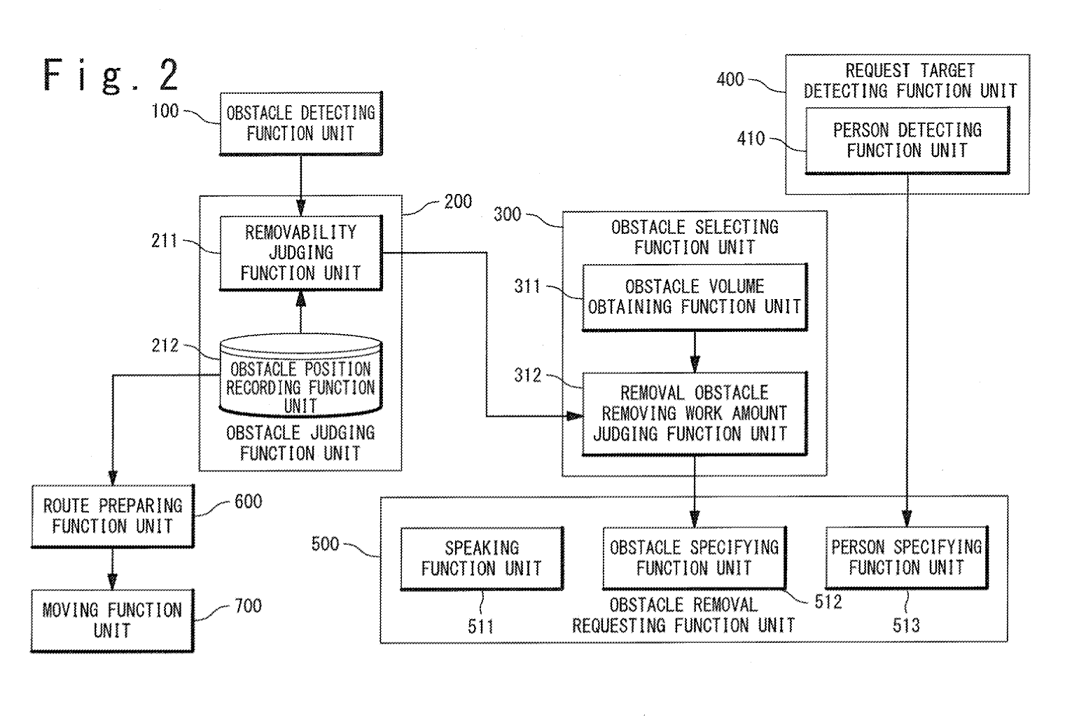

This exemplary embodiment will be described below in detail with reference to FIG. 2.

FIG. 2 is a block diagram showing a detail of the configuration of the autonomously moving body according to the first exemplary embodiment of the present invention. The autonomously moving body in this exemplary embodiment includes the obstacle detecting function unit 100, the obstacle judging function unit 200, the obstacle selecting function unit 300, the request target detecting function unit 400, the obstacle removal requesting function unit 500, a route preparing function unit 600 and a moving function unit 700.

The obstacle detecting function unit 100 detects an obstacle around the autonomously moving body. The detection result of the obstacle detecting function unit 100 is sent to the obstacle judging function unit 200 (a removability judging function unit 211).

The obstacle judging function unit 200; when judging that all of the routes through which the autonomously moving body moves to a destination are blocked by the obstacles, judges whether or not the obstacles detected by the obstacle detecting function unit 100 can be removed. The judgment result of the obstacle judging function unit 200 is sent to the obstacle selecting function unit 300. The obstacle judging function unit 200 includes the removability judging function unit 211 and an obstacle position recording function unit 212.

The removability judging function unit 211 judge whether or not the obstacles can be removed by comparing the detection result of the obstacle detecting function unit 100 with previously-obtained position information of the obstacles. The judgment result of the removability judging function unit 211 is sent to the obstacle selecting function unit 300 (a removal obstacle removing work amount judging function unit 312).

The obstacle position recording function unit 212 records the position information of the obstacles previously obtained by the autonomously moving body. The information recorded in the obstacle position recording function unit 212 is sent to the removability judging function unit 211 and the route preparing function unit 600, as necessary.

The obstacle selecting function unit 300, when the obstacle judging function unit 200 judges that there is a removable obstacle, estimates the volume of the obstacle. When there is a plurality of removable obstacles, the obstacle selecting function unit 300 selects the obstacle so that the cost required for a person as a request assistant becomes small. Here, the cost implies a necessary work amount for the person of the request assistant in order to remove the obstacle. The cost may be calculated on the basis of at least one piece of information included in the group of the volume, the weight, the shape, the length, the surface area, the kind of the obstacle, or the distance from the request target. The judgment result of the obstacle selecting function unit 300 is sent to the obstacle removal requesting function unit 500. The obstacle selecting function unit 300 includes an obstacle volume obtaining function unit 311 and the removal obstacle removing work amount judging function unit 312.

The obstacle volume obtaining function unit 311, when the obstacle judging function unit 200 judges that there is the removable obstacle, estimates the volume of the obstacle. The estimation result of the obstacle volume obtaining function unit 311 is sent to the removal obstacle removing work amount judging function unit 312.

The removal obstacle removing work amount judging function unit 312 uses the information of the volume of the obstacle obtained by the obstacle volume obtaining function unit 311 and selects a removal target from the obstacles judged to be removable by the removability judging function unit 211. At this time, the removal obstacle removing work amount judging function unit 312 selects the obstacle to reduce the cost required for a person serving as a request target. The selection result of the removal obstacle removing work amount judging function unit 312 is sent to the obstacle removal requesting function unit 500 (an obstacle specifying function unit 512).

The request target detecting function unit 400 detects a request target when recognizing that all of the routes through which the autonomously moving body moves to the destination are blocked by the obstacles. In particular, a person detecting function unit 410 of the request target detecting function unit 400 detects a person around the autonomously moving body. The detection result of the person detecting function unit 410 is sent to the obstacle removal requesting function unit 500 (a person specifying function unit 513).

The obstacle removal requesting function unit 500 requests the person detected by the person detecting function unit 410 in order to remove the obstacle selected by the obstacle selecting function unit 300. The obstacle removal requesting function unit 500 includes a speaking function unit 511, an obstacle specifying function unit 512 and the person specifying function unit 513.

The person specifying function unit 513 uses the information of the person detected by the person detecting function unit 410 and specifies the person to be requested.

The obstacle specifying function unit 512 specifies the obstacle selected by the removal obstacle removing work amount judging function unit 312, for the person serving as the request target.

The speaking function unit 511 carries out a speech for requesting the request target to remove the obstacle.

The route preparing function unit 600 prepares a route to a destination of the autonomously moving body. The route preparing function unit 600 is attained by, for example, an information processing apparatus such as a computer for processing the information (data) from the obstacle judging function unit 200 and the like by using software (programs).

The moving function unit 700 attains movement of the autonomously moving body. The moving function unit 700 is attained by, for example, an information processing apparatus such as a computer for processing the information (data) from the route preparing function unit 600 and the like by using software (programs), and the hardware for moving the autonomously moving body in response to the information (data) from the information processing apparatus.

As for the above-described configuration elements, the respective operations will be described below in detail.

The obstacle detecting function unit 100 detects an obstacle existing around the moving body. The obstacle detecting function unit 100, for example, includes: a camera (not shown) that images a landscape around the moving body to convert into an electronic signal; and a picture processing function unit (not shown). The obstacle detecting function unit 100 may detect the obstacle by obtaining a camera picture from the camera and exploratively matching the inside of the camera picture with a particular pattern through the picture processing function unit. Other than the matching, a region satisfying a particular condition may be detected as the obstacle by analyzing an edge or texture.

Also, the obstacle detecting function unit 100 may includes two or more cameras. Then, those cameras may be used to obtain a plurality of camera pictures, and the picture processing function unit may be used to detect, as the obstacle, the region in which a disparity satisfies a particular condition on the basis of a disparity picture through stereo viewing. Moreover, the obstacle may be detected by restoring a three-dimensional shape based on the pictures inputted from the respective cameras to examine whether or not a physical body exists on the flat surface on which the moving body moves. In addition, the obstacle detecting function unit 100 may include LRF (Laser Range Finder: not shown). The picture processing function unit may be used to detect, as the obstacle, the region in which distance information obtained by the LRF satisfies the particular condition. The LRF is the apparatus for detecting a peripheral physical body through the reflection of emitted laser beam. Moreover, the obstacle detecting function unit 100 may include an ultrasonic sensor (not shown). In the picture processing function unit, the ultrasonic sensor may be used to detect the obstacle.

The obstacle recording function unit 212 records information of positions of obstacles. The removability judging function unit 211 compares the information of the position of the obstacle detected by the obstacle detecting function unit 100 with the information of the positions of the obstacles recorded in the obstacle recording function unit 212 in the autonomously moving body. Consequently, the removability judging function unit 211 judges whether or not the obstacle can be removed.

For example, the position information of the detected obstacle and the position information recorded in the obstacle recording function unit 212 may be assumed to be the grid-shaped map in which the place where the obstacle exists is represented by 1 (one) and the place where it does not exist is represented by 0 (zero).

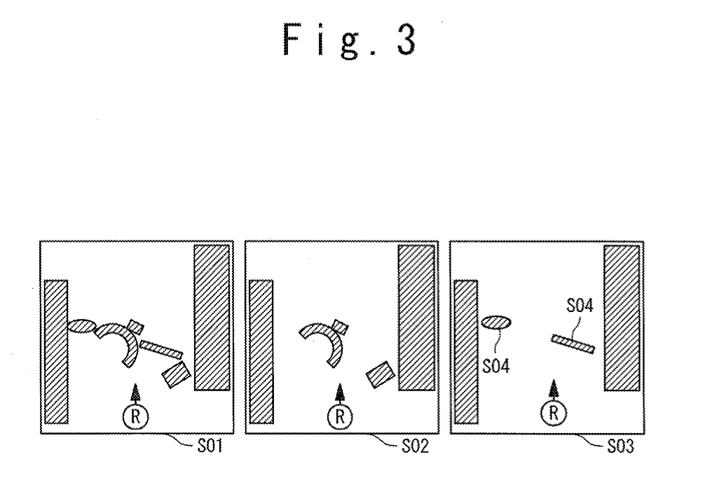

FIG. 3 is a map group describing a processing example of the obstacle judging function unit in this exemplary embodiment.

In FIG. 3, a map S01 indicates the newest obstacle position obtained by the obstacle detecting function unit 100. Also, a map S02 indicates the position of the obstacle recorded in the obstacle recording function unit 212. The removability judging function unit 211 compares the map S01 and the map S02, and prepares the map S03 in which only obstacles that does not exist on the map S02 but exists on the map S01 are extracted. The removability judging function unit 211 may judge that obstacles S04 existing inside the map S03 are the removable obstacles.

Also, after the completion of the movement of the autonomously moving body, the newest obstacle position obtained by the obstacle detecting function unit 100 may be reflected into the map recorded in the obstacle recording function unit 212. Specifically, a value at a grid position (x, y) of the map S01 indicating the newest obstacle position is defined as P1 (x, y). Then, a value P (x y) at the grid position (x, y) of the map indicating the position of the obstacle to be newly re-recorded is defined as follows.

P(x,y)=P1(x,y) (1)

Consequently, the newest obstacle position may be reflected into (updated to) the map recorded in the obstacle recording function unit 212. Also, a reflecting method that considers a time and a nearby grid value may be used.

In addition, the removability judging function unit 211 may judge that the obstacle can be removed, based on the judgment criteria in which the shape of the obstacle on the map is a predetermined shape, the volume is equal to or less than a certain value, or the other items, without using the information of the positions of the previously detected obstacles. Also, when the obstacle detecting function unit 100 includes the camera, the removability judging function unit 211 may judge the removable obstacle based on the edge or texture of the obstacle inside the imaged picture, or the particular pattern, without using the map. Moreover, when the autonomously moving body includes a device (not shown) that can obtain information of an ID tag embedded in the obstacle, the removability judging function unit 211 may judge whether or not the obstacle can be removed, based on the information obtained by using its device.

As for the obstacle judged to be removable by the removability judging function unit 211, the obstacle volume obtaining function unit 311 obtains the volume. For example, when the autonomously moving body records the position information of the obstacle as the grid on the map, the obstacle volume obtaining function unit 311 can estimate the volume of the obstacle as follows. That is, the area of the region indicating the obstacle is regarded as the bottom area of the obstacle. Moreover, its height is assumed to have a predetermined constant value. Then, the volume of the obstacle may be calculated.

As the method for the obstacle volume obtaining function unit 311 to obtain the volume of the obstacle, in addition thereto, the following method is exemplified. When the obstacle volume obtaining function unit 311 can obtain only the position of the surface of the obstacle such as in the case of using the LRF, the obstacle volume obtaining function unit 311 obtains the length of a line that indicates the surface of the obstacle on the map. Then, the obstacle volume obtaining function unit 311 may calculate the volume of the obstacle, by assuming a depth length and a height to predetermined values.

As still another method, the obstacle is imaged by the camera, and the volume of the obstacle may be calculated based on the area corresponding to the obstacle indicated in the picture.

As still another method, the obstacle is imaged by a plurality of cameras, and three-dimensional model data of the obstacle is prepared, and the volume of the obstacle may be calculated based on its three-dimensional model data.

Incidentally, in order to recognize the obstacle, the obstacle volume obtaining function unit 311 may obtain the shape of the obstacle, other than the volume of the obstacle. In order to obtain the shape of the obstacle, the obstacle volume obtaining function unit 311 may use the combination of map information, laser sensor information, a camera picture and the like. Also, when a weight sensor exists on a floor and then the autonomously moving body can get its weight information, the obstacle volume obtaining function unit 311 may obtain the weight of the obstacle.

In addition to them, for example, information with regard to the category of the obstacle such as a building structure, furniture, a regular life tool or the like can be information useful for estimating the cost required for the request target. In this case, the obstacle volume obtaining function unit 311 may obtain those information.

The removal obstacle removing work amount judging function unit 312 selects the obstacle whose volume is the smallest, from the obstacles judged to be removable by the removability judging function unit 211. At that time, the removal obstacle removing work amount judging function unit 312 obtains the volume of each obstacle from the obstacle volume obtaining function unit 311.

For example, the number of the obstacles judged to be removable by the removability judging function unit 211 is assumed to be n, and an ID (IDentification number) of each of n number of the obstacles is assumed to be i. Here, 1≦i≦n. Moreover, for each of the obstacles obtained by the obstacle volume obtaining function unit 311, the volume of the obstacle i is assumed to be Vi, and the obstacle whose volume is the smallest is selected. Here, the ID value of the obstacle having the smallest volume in the n number of the obstacles is assumed to be m. However, 1≦m≦n. The ID value m is calculated by the following equation (2).

m=arg(min(Vi)) (2)

Incidentally, as mentioned above, when the obstacle volume obtaining function unit 311 obtains the information with regard to the category instead of the volume of the obstacle, the following selecting method may be used. That is, for example, a category list of the obstacles is prepared in advance, and the obstacle volume obtaining function unit 311 or a storing unit installed around it stores the category list. Here, items of the categories are arranged in an order starting from an item with a smaller load that is imposed on the request target when the request target removes the obstacle. The obstacle belonging to the category in which the cost required for the request target is the smallest may be randomly selected from the obstacles that are judged to be removable by the removability judging function unit 211.

In addition to them, the removal obstacle removing work amount judging function unit 312 may select the removable obstacle as the removal target so that the obstacle removal cost required for the request target is minimized, by using the method preferable for each piece of information obtained for the obstacle.

The person detecting function unit 410 detects a person existing around the moving body. The person detecting function unit 410 may detect the person, for example, by extracting a face region from the picture obtained by the camera. Also, the person detecting function unit 410 may detect the person by discovering the pattern in which the person exists, from distance information obtained by the LRF. In addition to it, the person detecting function unit 410 may detect the person by using sensor information obtained by the ultrasonic sensor or person sensor. The person detecting function unit 410 may further estimate existence of the person by detecting a sound source direction caused by a microphone array and the like, instead of the detection of the person.

The speaking function unit 511 requests the person detected by the person detecting function unit 410, to remove the obstacle that is selected as the removal target by the removal obstacle removing work amount judging function unit 312. The speaking function unit 511 carries out the request by speaking, for example, “Please remove this” through a synthesis speech. Also, the speaking function unit 511 may carry out the request by speaking “please, remove this XX” and the like, when the category of the obstacle is obtained.

The speaking function unit 511 may also carry out the request by generating an alarm sound or changing a lighting pattern of LED fixed to the moving body, other than the speaking.

The obstacle specifying function unit 512 indicates the obstacle, which is selected as the removal target by the removal obstacle removing work amount judging function unit 312, to the person detected by the person detecting function unit 410. For example, when the moving body includes a head portion and a torso portion and a pose can be held while an angle of the head portion is different from an angle of the torso portion, the obstacle specifying function unit 512 may point out the obstacle serving as the removal target, by orienting the head portion only to the direction of the obstacle.

Also, when the moving body holds a directional light emitter (such as a laser pointer, a spot light and the like), the obstacle specifying function unit 512 may point out the obstacle serving as the removal target by emitting the light emitted by the light emitter to the obstacle.

The person specifying function unit 513 nonverbally transmits that the requested target person is the person detected by the person detecting function unit 410. For example, when the moving body includes a head portion and a torso portion and a pose can be held while an angle of the head portion is different from an angle of the torso portion, the person specifying function unit 513 may indicate the fact of the request by orienting the head portion to the direction of the request target person.

In addition, when the autonomously moving body has a shape having the directional property in which a direction of a visual line can be observed from outside, the person specifying function unit 513 may indicate the fact of the request by orienting the visual line to the direction of the request target person.

The route preparing function unit 600 prepares a route so that the moving body can arrive at the destination while avoiding the obstacles. Here, the route preparing function unit 600 uses the information related to the positions of the obstacles that are previously detected and recorded in the obstacle position recording function unit 212.

Here, the information of the position of the obstacle may be recorded, for example, as the grid-shaped map. In this case, the route preparing function unit 600 may carry out the route preparation, for example, by using the A* algorism of Hart, P. E.; Nilsson, N. J.; Raphael, B. (1968), “A Formal Basis for the Heuristic Determination of Minimum Cost Paths”, IEEE Transactions on Systems Science and Cybernetics SSC4(2) pp. 100-107.

In addition, the route preparing function unit 600 may use a route searching method that is preferable for a kind of information related to the positions of the obstacles which are recorded in the obstacle position recording function unit 212.

The moving function unit 700 is not especially limited, when this is configured preferably for the movement of the moving body. The moving function unit 700 may be, for example, the right and left two motorized wheels.

The entire operation of this exemplary embodiment will be described below.

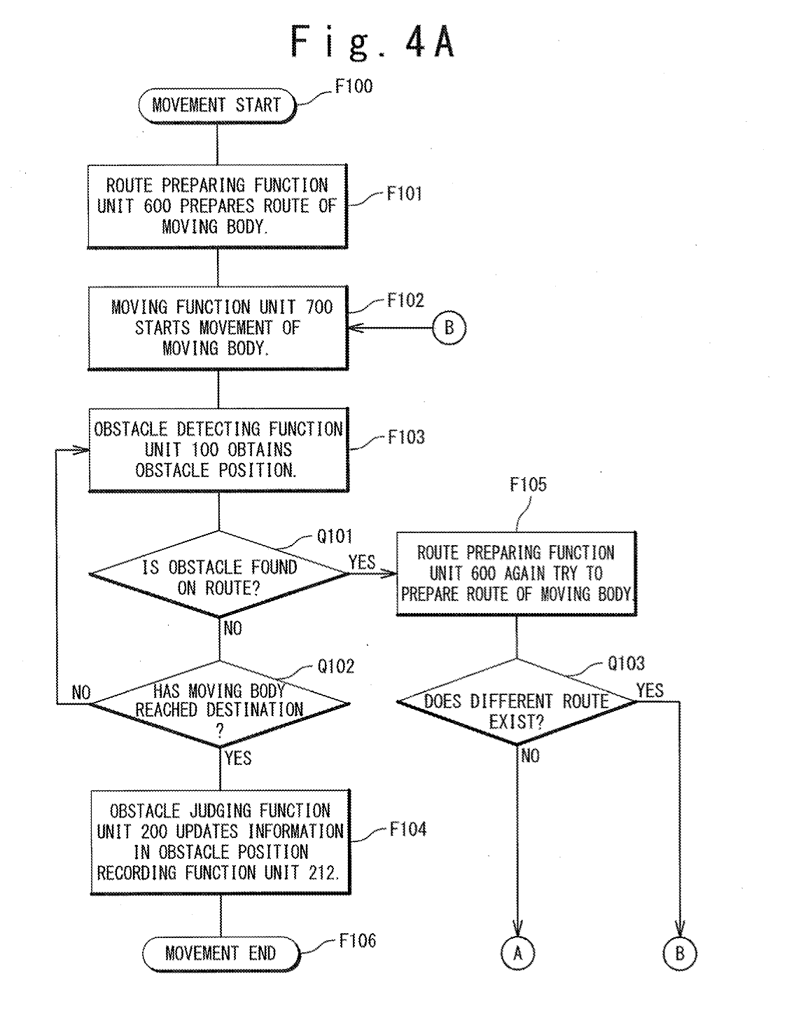

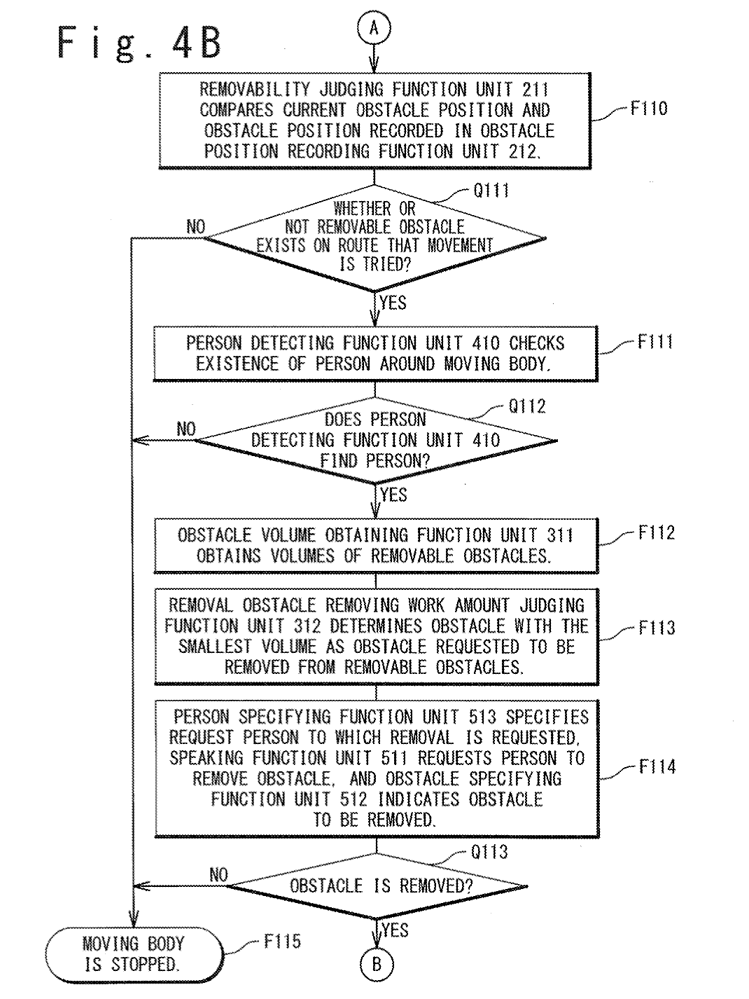

FIGS. 4A and 4B are flowcharts describing the entire operation procedure of the autonomously moving method in this exemplary embodiment.

A start point F100 in the flowchart in FIG. 4A indicates the situation in which it is necessary to move to the destination set for the autonomously moving body.

At first, at a step F101, the route preparing function unit 600 prepares a route to a destination from a current position of the autonomously moving body.

Next, at a step F102, the moving function unit 700 starts a movement of the autonomously moving body toward the destination.

Incidentally, during the movement of the autonomously moving body, at a step F103, the obstacle detecting function unit 100 always continues to obtain an obstacle position.

During the movement of the autonomously moving body, if, at a step Q101, the obstacle detecting function unit 100 does not find any obstacle on the route of the moving body (Q101: No), and if, at a step Q102, the obstacle judging function unit 200 judges that the moving body has reached the destination (Q102: Yes), the movement of the moving body is completed at a step F106. At this time, at a step F104, the obstacle judging function unit 200 updates information recorded in the obstacle position recording function unit 212, to the information in which information of the obstacle position newly obtained by the obstacle detecting function unit 100 is reflected.

During the movement of the autonomously moving body, at the step Q101, if the obstacle detecting function unit 100 finds the obstacle on the route of the moving body (Q101: Yes), the operational flow proceeds to a step F105. At the step F105, the route preparing function unit 600 tries to again prepare a route to the destination.

If at a step Q103, a different route is judged to exist (Q103: Yes), the operational flow returns to the step F102, and the movement of the moving body is restarted based on the route.

If at the step Q103, a different route is judged not to exist (Q103: No), the operational flow proceeds to a step F110 in FIG. 4B. At the step F110, the removability judging function unit 211 compares position information of the obstacle newly obtained in the current movement and the position information of the obstacle recorded in the obstacle position recording function unit 212. As the result of this comparison, the removability judging function unit 211 checks whether or not a removable obstacle exists on the route through which the movement is tried, at a step Q111.

Here, if a removable obstacle does not exist (Q111: No), the removability judging function unit 211 judges that the moving body cannot arrive at the destination. Then, the operational flow proceeds to the step F115 at which the movement of the moving body is stopped.

On the contrary, if a removable obstacle exists (Q111: Yes), at a step Fill, the person detecting function unit 410 checks existence of a person existing around the moving body.

If the person detecting function unit 410 does not find a person at a step Q112 (Q112: No), the person to which removal of the obstacle is requested is not considered to exist. Thus, the movement of the autonomously moving body is stopped at the above-described step F115.

If the person detecting function unit 410 finds a person at the step Q112 (Q112: Yes), the operational flow proceeds to a step F112. At the step F112, the obstacle volume obtaining function unit 311 obtains the respective volumes of the removable obstacles.

Next, at a step F113, the removal obstacle removing work amount judging function unit 312 determines an obstacle with the smallest volume as an obstacle requested to be removed, from the removable obstacles.

Moreover, at a step F119, the person specifying function unit 513 specifies the request target person to which the removal of the obstacle is requested. Then, the speaking function unit 511 requests the request target person to remove the obstacle. At this time, the obstacle specifying function unit 512 indicates the obstacle serving as the removal target, to the request target person.

If at a step Q113, the autonomously moving body checks that the obstacle is removed (Q113: Yes), the operational flow returns to the step F102, and the autonomously moving body again starts the movement to the destination.

On the contrary, if at the step Q113, the autonomously moving body checks that the obstacle is not removed (Q113: No), the operational flow proceeds to the step F115, and the movement of the autonomously moving body is stopped.

The effect of this exemplary embodiment will be described below.

In the configuration of this exemplary embodiment, if there is a plurality of removable obstacles, the volumes of the obstacles are estimated to select an obstacle with the smallest volume. Thus, the cost required for a person can be reduced when the obstacle is removed. However, as described above, the cost may be calculated on the basis of at least one piece of information that is included in the weight, the shape, the length, the surface area, the kind, or the distance from the request target, other than the volume of the obstacle.

### Second Exemplary Embodiment

The second exemplary embodiment for carrying out the present invention will be described below in detail with reference to the drawings.

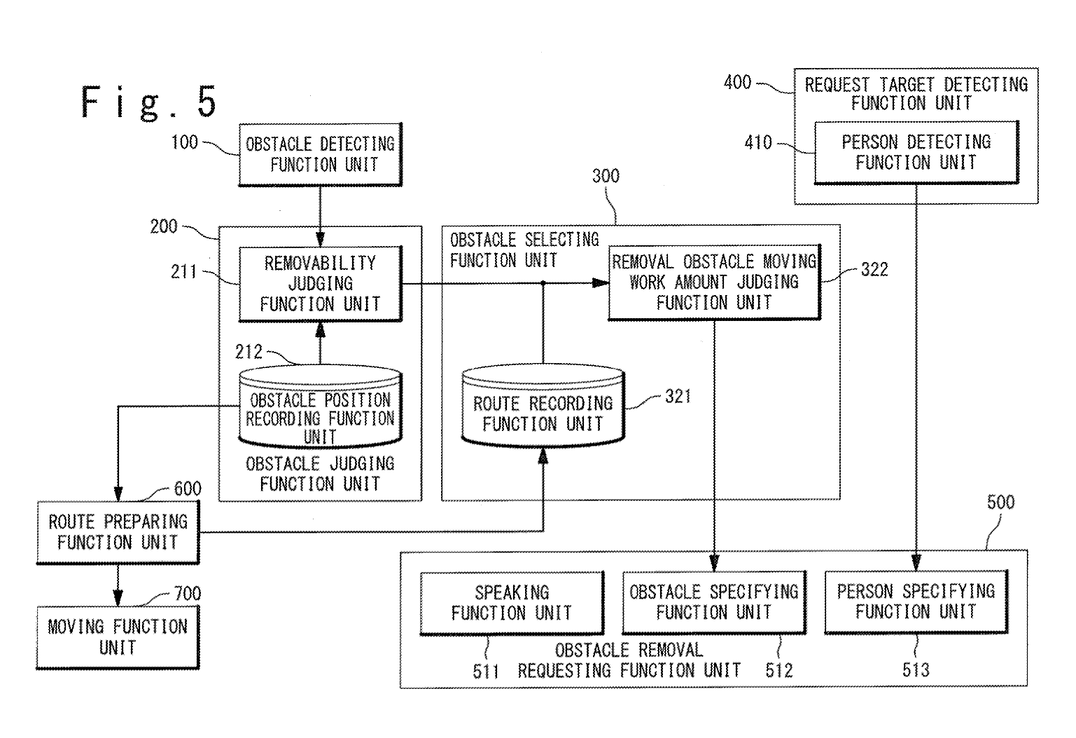

FIG. 5 is a block diagram showing a configuration of an autonomously moving body in the second exemplary embodiment of the present invention. The autonomously moving body in this exemplary embodiment includes an obstacle detecting function unit 100, an obstacle judging function unit 200, an obstacle selecting function unit 300, a person detecting function unit 410 in a request target detecting function unit 400, an obstacle removal requesting function unit 500, a route preparing function unit 600 and a moving function unit 700.

Here, the obstacle detecting function unit 100 detects an obstacle around the moving body. The obstacle judging function unit 200, when recognizing that all of the routes through which the moving body moves to a destination are blocked by obstacles, judges whether or not the obstacles detected by the obstacle detecting function unit 100 can be removed. When the obstacle judging function unit 200 judges existence of the removable obstacle, the obstacle selecting function unit 300 uses previously-prepared route information and selects an obstacle so that a movement distance is made short when the moving body moves to the destination. When all of the routes through which the moving body moves to the destination are blocked by the obstacles, the person detecting function unit 41U detects a person around the moving body. When the obstacle selecting function unit 300 can select the obstacle and then the person detecting function unit 910 can detect the person, the obstacle removal requesting function unit 500 requests the person to remove the obstacle. The route preparing function unit 600 prepares the route to the destination of the moving body. The moving function unit 700 attains the movement of the moving body.

The obstacle judging function unit 200 includes a removability judging function unit 211 and an obstacle position recording function unit 212. Here, the removability judging function unit 211 judges whether or not the obstacle can be removed by comparing the newest obstacle position information obtained by the obstacle detecting function unit 100 with previously-obtained obstacle position information. Also, the obstacle position recording function unit 212 records the previously-obtained obstacle position information.

The obstacle selecting function unit 300 includes a route recording function unit 321 and a removal obstacle moving work amount judging function unit 322. Here, the route recording function unit 321 records the route which is prepared by the route preparing function unit 600 and through which the moving body has tried to move. Also, the removal obstacle moving work amount judging function unit 322 selects a removal target obstacle from the obstacles that are judged to be removable by the removability judging function unit 211. As the selection criteria, the obstacle is selected, which exists on the route having the shortest distance to the destination of the routes which are recorded in the route recording function unit 321 and through which the moving body has tried to move.

The obstacle removal requesting function unit 500 includes a speaking function unit 511, an obstacle specifying function unit 512 and a person specifying function unit 513. Here, the speaking function unit 511 makes the speech in which removal of the obstacle is desired. Also, the obstacle specifying function unit 512 specifies the obstacle, which is selected by the removal obstacle removing work amount judging function unit 312, to the person. Also, the person specifying function unit 513 uses information of the person detected by the person detecting function unit 410 and specifies the person to be requested.

The foregoing configuration elements are operated as follows, respectively.

The obstacle detecting function unit 100 is operated similarly to the first exemplary embodiment. Also, the operation of the obstacle detecting function unit 100 may be changed to the application operation example noted in the first exemplary embodiment.

The removability judging function unit 211 and the obstacle recording function unit 212 are operated similarly to the first exemplary embodiment. Also, the operations of the removability judging function unit 211 and the obstacle recording function unit 212 may be changed to the application operation examples noted in the first exemplary embodiment, respectively.

The route recording function unit 321 records route information. This route information is prepared by the route preparing function unit 600, and the autonomously moving body tries to move using this route information. For example, when the information recorded in the obstacle position recording function unit 212 is recorded as a grid-shaped map, the route of the autonomously moving body may be recorded by using a grid coordinate value on the map. Also, the recorded route information may be represented by an equation.

The removal obstacle moving work amount judging function unit 322 firstly extracts a route. Here, the route extracted by the removal obstacle moving work amount judging function unit 322 is the route through which the moving body has tried to move, which is recorded in the route recording function unit 321, and on which the obstacle judged to be removable by the removability judging function unit 211 exists.

Next, the removal obstacle moving work amount judging function unit 322 selects the route, in which the route length to the destination is the shortest, from the extracted routes, and further selects the obstacle that is located on the shortest route and also judged to be removable.

As an example, it is assumed that the map information is represented in the grid shape and then the position information of the removable obstacle is recorded in the grid-shaped map information. An integer of 1 or more is correlated as an ID value to the obstacle, and this ID value is recorded in the map grid at which the obstacle is located. In the map grid, the place where the obstacle does not exist is assumed to be represented by 0 (zero) instead of the ID value. The position information of the moving body is represented by a map coordinate (x, y) on the map grid. The route information of the moving body is recorded as a set of grid coordinate values on the map. ID values are also assigned to the respective routes.

In the map coordinate (x, y) in the foregoing example, a value indicating existence of the obstacle or an ID value is assumed to be M (x, y), the route through which the moving body has tried to move is assumed to be Pi (i is an ID value of the route), and a coordinate value configuring Pi is assumed to be Pij (j is an ID value of the set element). Then, In each Pi, whether or not there is j satisfying the equation (3) is examined.

M(Pij)≠0 (3)

The route Pi satisfying this equation (3) implies that the removable obstacle exists on the route.

As mentioned above, when the set of the route's in which the removable obstacles exist on the route is obtained, next, the route Pi in which the number of the coordinate elements configuring the route is the smallest is selected from this set. Here, the ID value of the route in which the number of the coordinate elements is the smallest is assumed to be m. Then, when the M(Pmj) that is not 0 is obtained, it is possible to select the obstacle that exists on the route in which the route length to the destination is the shortest and judged to be removable.

In addition to the above route length, reducing the cost of the autonomously moving body, namely, the work amount when the autonomously moving body moves after the removal of the obstacle may be the index to select the obstacle. In this case, the position, the movement route, the kinetic energy, the electric power consumption, the charge remaining amount, the load weight and the operation history of the autonomously moving body and the like may be used as the specific indexes.

The person detecting function unit 410 is operated similarly to the first exemplary embodiment. Also, the operation of the person detecting function unit 410 may be changed to the application operation example noted in the first exemplary embodiment.

The speaking function unit 511, the obstacle specifying function unit 512 and the person specifying function unit 513 are operated similarly to the first exemplary embodiment, respectively. Also, the speaking function unit 511, the obstacle specifying function unit 512 and the person specifying function unit 513 may be changed to the application operation examples noted in the first exemplary embodiment, respectively.

The route preparing function unit 600 is operated similarly to the first exemplary embodiment. Also, the operation of the route preparing function unit 600 may be changed to the application operation example noted in the first exemplary embodiment.

The moving function unit 700 is operated similarly to the first exemplary embodiment. Also, the operation of the moving function unit 700 may be changed to the application operation example noted in the first exemplary embodiment.

The entire operation of this exemplary embodiment will be described below in detail.

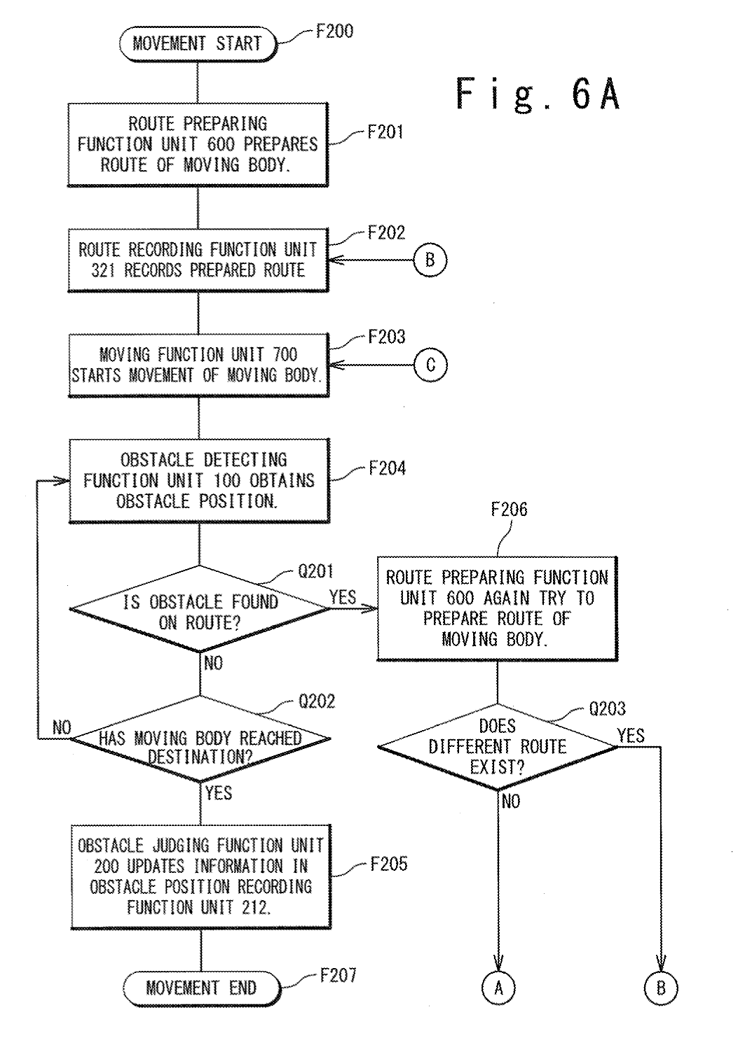

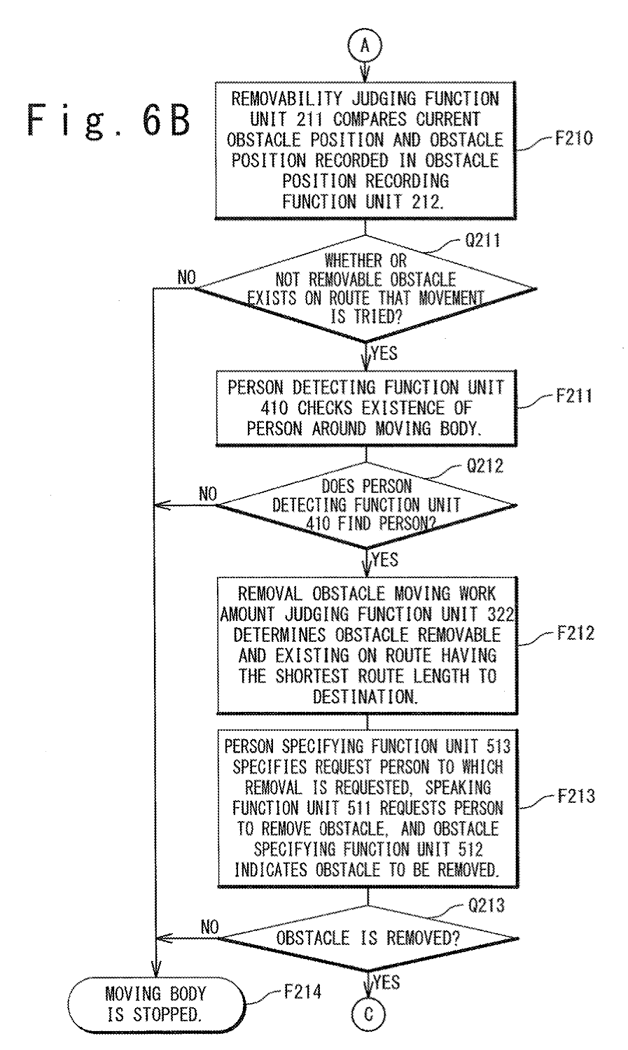

FIGS. 6A and 6B are flowcharts describing in detail the entire operation procedure of the autonomously moving method in this exemplary embodiment.

A start point F200 of the flowchart indicates the situation in which necessity of moving to a destination set for the autonomously moving body arises.

At first, at a step F201, the route preparing function unit 600 prepares a route to the destination from the current position of the autonomously moving body.

At a step F202, the route recording function unit 321 records the route prepared at the step F201.

The subsequent steps F203, F204, Q201, Q202, F205, F206 and F207 carry out the same processes as the steps F102, F103, Q101, Q102, F104, F105 and F106 in FIG. 4A in the first exemplary embodiment, respectively.

The case is considered in which at the step Q201, the obstacle detecting function unit 100 detects the obstacle existing on the route of the moving body (Q201: Yes) and as the result of the execution of the route re-preparation of the route preparing function unit 600 at the step F206, the different route exists at the step Q203 (Q203: Yes). In such a case, the operational flow returns to the step F202 at which the route recording function unit 321 records the prepared route, and the moving body re-starts the movement toward the destination.

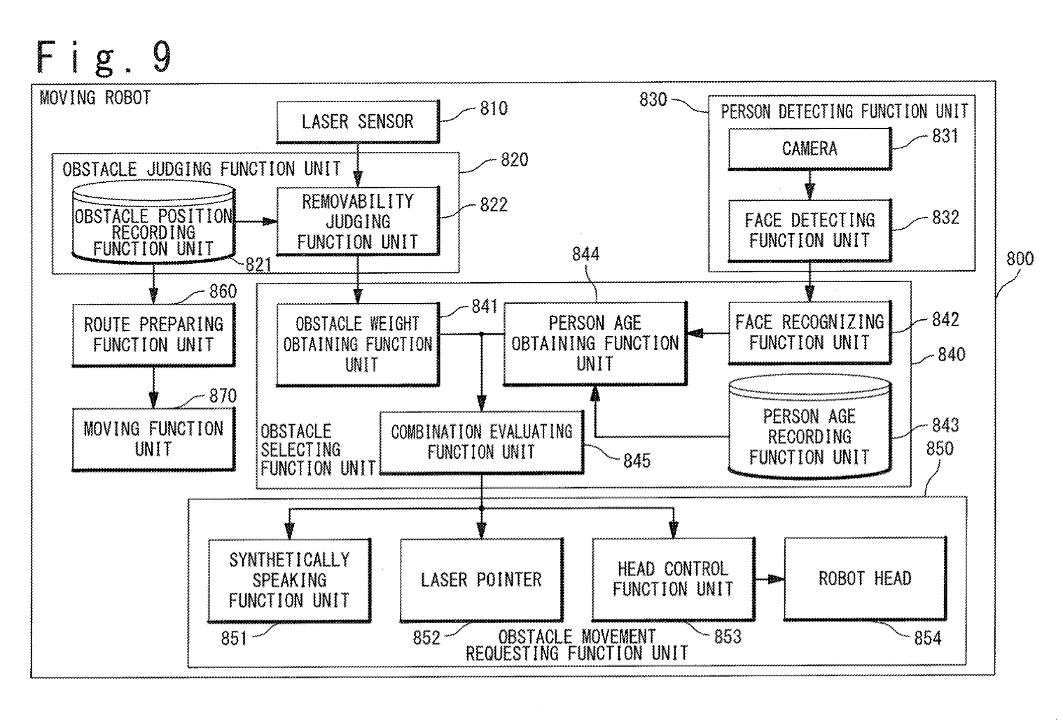

The case is considered in which at the step Q201, the obstacle detecting function unit 100 detects the obstacle existing on the route of the moving body (Q201: Yes) and as the result of the execution of the route re-preparation of the route preparing function unit 600 at the step F206, the different route does not exist at the step Q203 (Q203: No). In such a case, the operational flow proceeds to the step F210 in FIG. 6B. Here, the steps F210, Q211 and F211 carry out the same processes as the steps F110, Q111 and Fill in FIG. 9B in the first exemplary embodiment, respectively.

At the steps F211 to Q212, if the person detecting function unit 410 can find a person around the autonomously moving body (Q212: Yes), at the step F212, the removal obstacle moving work amount judging function unit 322 determines a removal target obstacle. Here, the obstacle serving as the removal target is a removable obstacle existing on the route having the shortest route length to the destination.

At the steps F211 to Q212, if the person detecting function unit 410 cannot find a person around the autonomously moving body (Q212: No), the person to which the removal of the obstacle is requested is not considered to exist. Thus, at a step F214, the movement of the autonomously moving body is stopped.

The subsequent steps F213, Q213 carry out the same processes as the steps F114, Q113 in FIG. 4E, in the first exemplary embodiment, respectively.

If at the step Q213, the removal of the obstacle is detected, the operational flow returns to the step F203 in FIG. 6A, and the movement toward the destination is re-started.

If at the step Q213, the obstacle is not removed, the operational flow proceeds to the step F214, and the movement is stopped.

The effect in this exemplary embodiment will be described below.

In this exemplary embodiment, when there is a plurality of removable obstacles, the removable obstacle existing on the route having the shortest route length to the destination is selected as the removal target. Thus, the cost required for the moving body can be reduced when it moves to the destination.

### Third Exemplary Embodiment

The third exemplary embodiment for carrying out the present invention will be described below in detail with reference to the drawings.

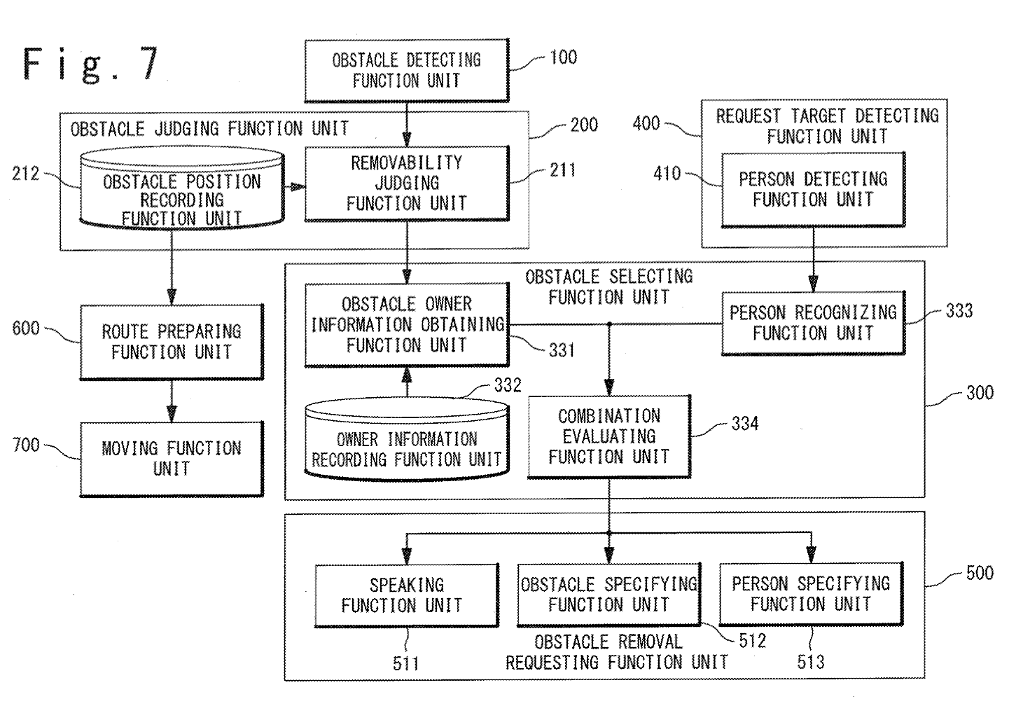

FIG. 7 is a block diagram describing in detail a configuration of the moving body in the third exemplary embodiment of the present invention. The autonomously moving body in this exemplary embodiment includes an obstacle detecting function unit 100, an obstacle judging function unit 200, a person detecting function unit 410, an obstacle selecting function unit 300, an obstacle removal requesting function unit 500, a route preparing function unit 600 and a moving function unit 700.

Here, the obstacle detecting function unit 100 detects an obstacle around the moving body. The obstacle judging function unit 200, when recognizing that all of the routes through which the moving body moves to the destination are blocked by the obstacles, judges whether or not the obstacle detected by the obstacle detecting function unit 100 is a removable obstacle. When all of the routes through which the moving body moves to the destination are recognized to be blocked by the obstacles, the person detecting function unit 410 detects a person around the moving body. When the obstacle judging function unit 200 finds the existence of the removable obstacle and also the person detecting function unit 410 detects the person around the moving body, the obstacle selecting function unit 300 selects the combination of the obstacle to be removed and the person to be requested. At this time, the selection of the combination of the removal target obstacle and the request target person is executed such that and a name of an owner of the obstacle and a name of the person to be requested coincide with each other by using information of the owner of the obstacle and recognition information of the person. When the obstacle selecting function unit 300 selects the obstacle to be removed and the person to be requested, the obstacle removal requesting function unit 500 requests the person to remove the obstacle. The route preparing function unit 600 prepares the route to the destination of the moving body. The moving function unit 700 attains the movement of the moving body.

The obstacle judging function unit 200 includes a removability judging function unit 211 and an obstacle position recording function unit 212. Here, the removability judging function unit 211 compares the newest obstacle position information obtained by the obstacle detecting function unit 100 and the previously-obtained obstacle position information to judge whether or not the obstacles can be removed. The obstacle position recording function unit 212 records the previously-obtained obstacle position information.

The obstacle selecting function unit 300 includes an obstacle owner information obtaining function unit 331, an owner information recording function unit 332, a person recognizing function unit 333 and a combination evaluating function unit 334. Here, with regard to the obstacle judged to be removable by the removability judging function unit 211, the obstacle owner information obtaining function unit 331 obtains information of its owner. The owner information recording function unit 332 records information of owners of obstacles. The person recognizing function unit 333 recognizes the person detected by the person detecting function unit 410. The combination evaluating function unit 334 extracts the combination of the obstacle and the person so that the owner name of the removable obstacle obtained by the obstacle owner information obtaining function unit 331 and the peripheral person name recognized by the person recognizing function unit 333 coincide.

The obstacle removal requesting function unit 500 includes a speaking function unit 511, an obstacle specifying function unit 512 and a person specifying function unit 513. Here, the speaking function unit 511 makes the speech in which the removal of the removal target obstacle is desired for the request target person. The obstacle specifying function unit 512 specifies the removal target obstacle selected by the removal obstacle removing work amount judging function unit 312, to the request target person. The person specifying function unit 513 uses the information of the person around the moving body that is detected by the person detecting function unit 410 and specifies the person to which the removal of the obstacle is requested.

The foregoing configuration elements are operated as follows, respectively.

The obstacle detecting function unit 100 is operated similarly to the first exemplary embodiment. Also, the operation of the obstacle detecting function unit 100 may be changed to the application operation example noted in the first exemplary embodiment.

The removability judging function unit 211 and the obstacle recording function unit 212 are operated similarly to the first exemplary embodiment. Also, the operations of the removability judging function unit 211 and the obstacle recording function unit 212 may be changed to the application operation examples noted in the first exemplary embodiment, respectively.

With regard to the removable obstacle obtained by the removability judging function unit 211, the obstacle owner information obtaining function unit 331 obtains the information of the owner. In order to obtain the information of the owner, for example, a visible pattern, such as a bar code, a QR cord or the like, which is defined for each owner is stuck on the obstacle, and the moving body is provided with a camera. With such configuration, the pattern stuck on the obstacle may be imaged by the camera and recognized, thereby obtaining the information of the owner of the obstacle.

Also, other than the visible pattern, an invisible marker such as an infrared marker or the like may be used, and a sensor such as an infrared camera or the like may be used to recognize the invisible marker.

In addition, the RFID (Radio Frequency IDentification) in which owner information is recorded may be built in the obstacle, and the moving body may obtain the information by using a receiver. Moreover, a natural pattern such as a shape, texture and the like of the obstacle may be obtained by using a camera or LRF.

The owner information recording function unit 332 correlates a predetermined pattern for specifying the owner of the obstacle and the owner name and records them. For example, when a bar code is used as the predetermined pattern, the number of the bar code and the name of the owner are correlated and recorded.

In addition, information of any type preferable for the obstacle owner information obtaining function unit 331 and the name of the owner may be correlated. For example, it is possible to correlate a natural pattern and the name of the owner, and with regard to this point, there is no special limit. Also, as the means for recording the correspondence information, the owner information may be manually registered with manpower. Moreover, for the autonomously moving body, the operation mode at which the person can dialogically record the information may be prepared, and the owner information may be registered at the operation mode.

The person recognizing function unit 333 recognizes the person detected by the person detecting function unit 410. For example, a face of the person may be imaged as a picture, and the person may be recognized by using a face recognizing method with Boosting of P. Viola and M. J. Jones, “Robust Real-Time Face Detection”, International Journal of Computer Vision, Vol. 57, No. 2, May 2004, pp. 137-154. In addition, depending on a color of clothes, the person may be recognized, or when information in a wireless tag possessed by the person is obtained by the moving body, the person may be recognized. When the person is recognized, there is no special limit, and other preferable method may be used.

The combination evaluating function unit 334 selects a combination of an obstacle and a person so that the owner of the removable obstacle obtained by the obstacle owner information obtaining function unit 331 and the person name obtained by the person recognizing function unit 333 coincide.

For example, it is assumed that as the removable obstacles, there are A and B, and the owners of those obstacles are referred to as a and b, respectively. Incidentally, hereafter, the relations between those obstacles and their owners are referred to as Aa, Bb, respectively.

Here, it is assumed that there are three persons around the moving body. Then, as the result of the recognition, the three persons are referred to as a, c and d, respectively. In this case, as the combinations of the owners of the obstacles and the person names, there are the six possibilities of (Aa-a), (Aa-c), (Aa-d), (Bb-a), (Bb-c) and (Bb-d).

Here, the combination in which the obstacle and the obtained person name coincide is only (Aa-a). So, the obstacle and the person to be selected are determined to be A and a, and the combination may be selected.

Also, as the selection of the combination of an obstacle and a person, it is not always required to be the same person as the owner of the obstacle, and a combination with the different person who seems to be sufficiently friendly with the owner is allowable. In this case, a scale indicating a close relation between respective persons, for example, “friendship” may be used. Data related to this friendship may be prepared in advance and supplied to the autonomously moving body.

Incidentally, in the above methods, in a case that there is a plurality of combinations, as described in the first exemplary embodiment, the combination including the obstacle that minimizes the cost required for the request target person may be selected when the obstacle is removed.

In addition, as described in the second exemplary embodiment, the combination including the obstacle that minimizes the cost required for the moving body may be selected when the moving body moves to the destination.

Moreover, in combination with the first or second exemplary embodiment, the moving body includes information other than the owner. Then, on the basis of them, the combination of the removal target obstacle and the request target person may be judged.

The person detecting function unit 410 is operated similarly to the first exemplary embodiment. Also, the operation of the person detecting function unit 410 may be changed to the application operation example noted in the first exemplary embodiment.

As for the obstacle selected by the combination evaluating function unit 334, the speaking function unit 511 requests the person combined with the obstacle to remove the obstacle. The operational content of the speaking function unit 511 may be equal to that noted in the first exemplary embodiment.

In addition, such as “Mr. XX, please remove YY”, the speaking function unit 511 may clearly specify the person name and the category of the obstacle and the like to inform the request target person of the request content. With this manner, the request item is transmitted more clearly.

The obstacle specifying function unit 512 indicates the obstacle selected by the combination evaluating function unit 334 to the person combined with the obstacle. The operational example of the obstacle specifying function unit 512 may be that noted in the first exemplary embodiment.

The person specifying function unit 513 nonverbally informs the person selected by the combination evaluating function unit 334 of the requested fact. The operational example of the person specifying function unit 513 may be that noted in the first exemplary embodiment.

The route preparing function unit 600 is operated similarly to the first exemplary embodiment. Also, the operation of the route preparing function unit 600 may be changed to the application operation example noted in the first exemplary embodiment.

The moving function unit 700 is operated similarly to the first exemplary embodiment. Also, the operation of the moving function unit 700 may be changed to the application operation example noted in the first exemplary embodiment.

The entire operation procedure of the autonomously moving method in this exemplary embodiment will be described below in detail.

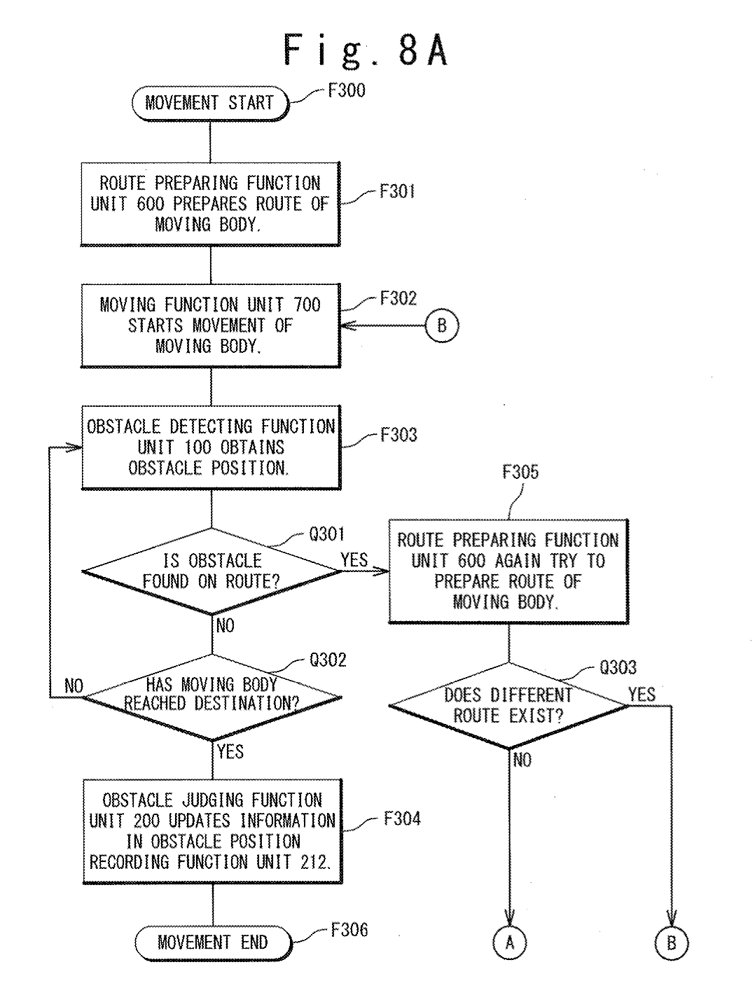

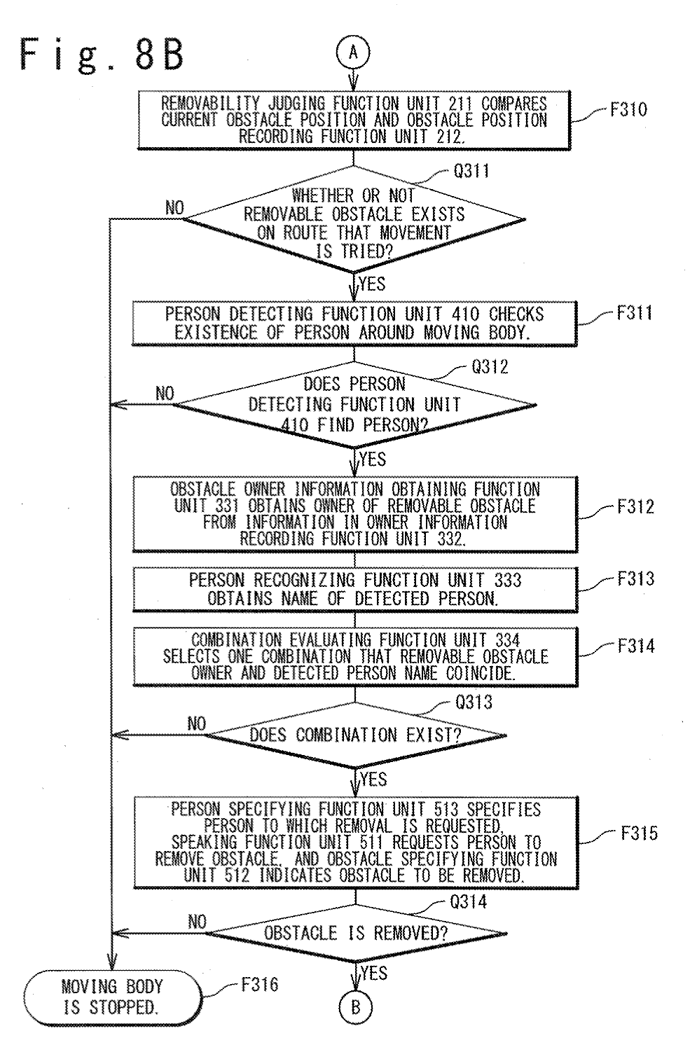

FIGS. 8A and 8B are flowcharts describing in detail the entire operation procedure of the autonomously moving method in this exemplary embodiment.

A start point F300 of the flowchart indicates the situation in which the necessity of carrying out the movement to the destination set for the autonomously moving body arises.

The steps F300, F301, F302, F303, Q301, Q302, F304, F305 and F306 in FIG. 8A carry out the same processes as the steps F100, F101, F102, F103, Q101, Q102, F109, F105 and F106 in FIG. 4A, respectively, which shows the entire operation in the first exemplary embodiment.

As a result after that at a step Q301, the obstacle detecting function unit 100 detects existence of the obstacle on the route of the moving body (Q301: Yes), at the step F305, the route preparing function unit 600 executes the route re-preparation, and if the different route exists at a step Q303 (Q303: Yes), the operational flow returns to the step F302. At this time, the route recording function unit 321 records the prepared route, and the autonomously moving body restarts the movement toward the destination.

As a result after that at the step Q301, the obstacle detecting function unit 100 detects existence of the obstacle on the route of the moving body (Q301: Yes), at the step F305, the route preparing function unit 600 executes the route re-preparation, and if the different route does not exist at the step Q303 (Q303: No), the operational flow proceeds to a step F310 in FIG. 8B.

The steps F310, Q311 and F311 in FIG. 8B carry out the same processes as the steps F110, Q111 and F111 in FIG. 4B in the first exemplary embodiment, respectively.

If at a step Q312, the person detecting function unit 410 can find a person around the autonomously moving body (Q312: Yes), at a step F312, the obstacle owner information obtaining function unit 331 obtains the owner of the removable obstacle. Here, the obstacle owner information obtaining function unit 331 uses the information recorded in the owner information recording function unit 332.

If at the step Q312, the person detecting function unit 410 cannot find a person around the autonomously moving body (Q312: No), the person to which the removal of the obstacle is requested is not considered to exist. Thus, the movement of the autonomously moving body is stopped at a step F316.

Next, at a step F313, the person recognizing function unit 333 obtains the name of the person detected by the person detecting function unit 410.

Then, at a step F314, the combination evaluating function unit 334 selects one combination of the removable obstacle and the owner in which the owner of the removable obstacle obtained at the step F312 and the person name obtained at the step F313 coincide.

If at a step Q313, the foregoing combination does not exist (Q313: No), the operational flow proceeds to a step F316, and the movement is stopped. On the contrary, if the foregoing combination exists (Q313: Yes), the operational flow proceeds to a step F315, and the same process as the step F114 in FIG. 4B in the first exemplary embodiment is executed.

At the step Q314, if the autonomously moving body checks the removal of the obstacle (Q314: Yes), at the step F302 in FIG. 8A, the autonomously moving body restarts the movement toward the destination.

At the step Q314, if the autonomously moving body cannot find the removal of the obstacle (Q314: No), the operational flow proceeds to the step F316, and the movement of the autonomously moving body is stopped.

The effect of this exemplary embodiment will be described below.

In this exemplary embodiment, when a plurality of removable obstacles exists on the route, the combination of the removal target obstacle and the request target person is selected such that the owner of the obstacle and the person to which the obstacle removal is requested coincide. Thus, the obstacle can be removed without any movement of the obstacle to a different place while the owner does not know the movement. Incidentally, the request target person may be retrieved on the basis of at least one piece of information included in the ID, the age, the gender, the body height, the schedule or the action history of the person.

### Example

The operations of the present invention will be described below by using the further specific examples, based on the first to third exemplary embodiments.

In this example, a moving robot serving as the autonomously moving body moves to a target position while autonomously avoiding obstacles. Also, the moving robot selects the obstacle to be removed and the person to which removal is requested, when the obstacle cannot be avoided. At this time, the moving robot considers the age of the person around the moving robot and the weight of the obstacle and carries out the selection to reduce the cost of the removal of the obstacle required for the person. The example will be described below with exemplifying the foregoing moving robot and the autonomously moving method.

FIG. 9 is a block diagram describing a detailed configuration of a moving robot 800 for carrying out an autonomous movement based on the autonomously moving method. The moving robot 800 includes a laser sensor 810, an obstacle judging function unit 820, a person detecting function unit 830, an obstacle selecting function unit 840, an obstacle movement requesting function unit 850, a route preparing function unit 860 and a moving function unit 870.

Here, the laser sensor 810 detects obstacles around the moving robot 800. The obstacle judging function unit 820, when recognizing that all routes to a destination from the current position of the moving robot 800 are blocked by the obstacles, judges whether or not the obstacles detected by the laser sensor 810 are removable. The person detecting function unit 830, when recognizing that all of the routes through which the moving robot 800 moves to the destination are blocked by the obstacles, detects persons around the moving robot 800. The obstacle selecting function unit 840 selects a combination of a removable target obstacle and a request target person, when there are the obstacles judged to be removable by the obstacle judging function unit 820 and also the person detecting function unit 830 detects the persons around the moving body. At this time, the obstacle selecting function unit 840 uses various information related to the age of the person and the weight of the obstacle and selects the combination of the removal target obstacle and the request target person. The obstacle movement requesting function unit 850 requests the request target person to remove the removal target obstacle, when the obstacle selecting function unit 840 selects the removal target obstacle and the request target person. The route preparing function unit 860 prepares the route to the destination of the moving robot 800. The moving function unit 870 attains the movement of the moving robot 800.

The obstacle judging function unit 820 includes a removability judging function unit 822 and an obstacle position recording function unit 821. Here, the removability judging function unit 822 compares the newest obstacle position information obtained by the laser sensor 810 and previously-obtained obstacle position information and consequently judges whether or not the obstacle can be removed. The obstacle position recording function unit 821 records the previously-obtained obstacle position information.

The person detecting function unit 830 includes a camera 831 and a face detecting function unit 832. Here, the camera 831 images the periphery of the moving robot 800. The face detecting function unit 832 detects the faces of the persons existing inside the picture obtained by the camera 831.

The obstacle selecting function unit 840 includes an obstacle weight obtaining function unit 841, a face recognizing function unit 842, a person age recording function unit 843, a person age obtaining function unit 844 and a combination evaluating function unit 845. Here, the obstacle weight obtaining function unit 841 obtains information of the weight of the obstacle that is judged to be removable by the removability judging function unit 822. The face recognizing function unit 342 recognizes the person detected by the person detecting function unit 830. The person age recording function unit 843 records the name of the person and the age of the person. The person age obtaining function unit 844 obtains the age of the person existing around the moving robot 800. At this time, the person age obtaining function unit 844 uses the person name recognized by the face recognizing function unit 842 and the age of the person recorded in the person age recording function unit 843. The combination evaluating function unit 845 selects the combination of the removal target obstacle and the request target person to reduce the cost required for the request target person, when the removal target obstacle is removed. At this time, the combination evaluating function unit 845 refers to the weight information of the obstacle obtained by the obstacle weight obtaining function unit 841 and the age of the person obtained by the person age obtaining function unit 844.

The obstacle removal requesting function unit 850 includes a synthetically speaking function unit 851, a laser pointer 852, a head control function unit 853 and a robot head 854. Here, the synthetically speaking function unit 851 makes a speech for requesting the request target person to remove the removal target obstacle. At this time, the synthetically speaking function unit 851 previously obtains the combination of the removal target obstacle and the request target person extracted by the combination evaluating function unit 845. The laser pointer 852 specifies the removal target obstacle to the request target person. The head control function unit 853 controls the motion and direction of the robot head 854 and the like and consequently indicates the request target person.

The operation example of the moving robot 800 will be described below.

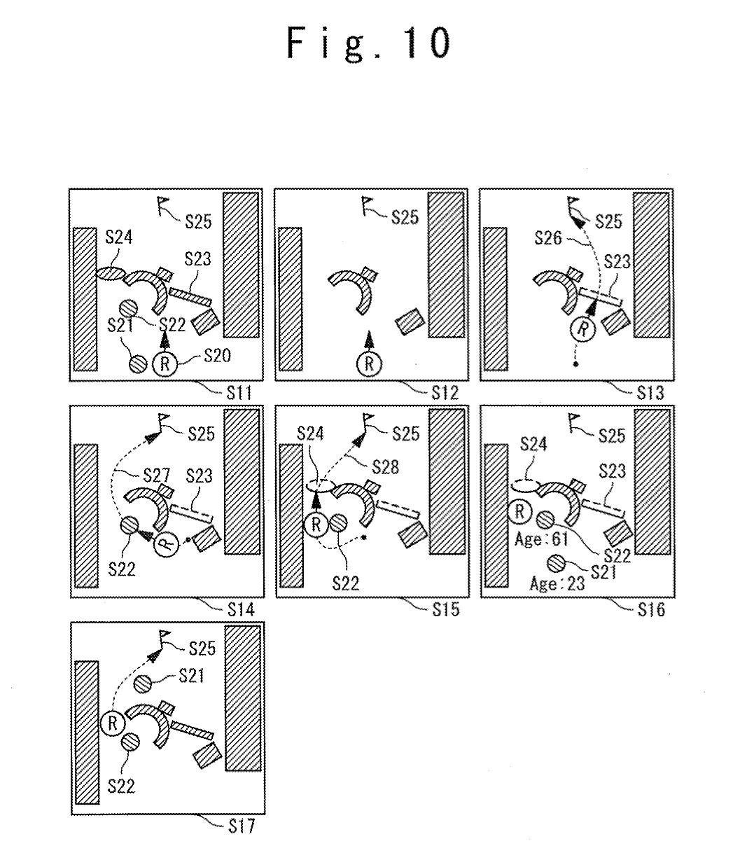

FIG. 10 is a map group indicating situation in which the space where the moving robot moves is changed, in order to describe the operation example of the moving robot 800 in this example.

A map S11 indicates the actual state before the moving robot 800 starts the movement. S20 indicates the moving robot 800, and S21, S22 indicate the persons, and S23, S24 and the other hatching portions on the map indicate the obstacles, and S25 indicates the destination of the moving robot 800, respectively.

A map S12 indicates the previously-obtained obstacle position data recorded in the obstacle position recording function unit 821.

On a map S13, the route preparing function unit 860 prepares the movement route of a dotted line S26 based on the map 512. A driving wheel 870 starts the movement of the moving robot along the movement route of the dotted line S26. Then, the obstacle S23 is found in the course of the movement, and the route is recognized to be blocked.

Incidentally, the laser sensor 810 is used to detect the obstacle. Thus, as for the obstacle S23, only the surface appearance is obtained. In order to indicate this fact, in the respective maps S11 to S17 in FIG. 10, the surfaces of the obstacles that can be obtained by the laser sensor are represented by the slid lines, and the surfaces of the obstacles that cannot be obtained by the laser sensor are represented by the dotted lines, respectively.

On the map S14, the route preparing function unit 860 prepares the movement route of a dotted line S27, based on the map S13 at this time. The driving wheel 870 moves the moving robot 800 along the movement route of the dotted line S27. Then, in the course of the movement, the person S22 is found, thereby recognizing that the route is blocked.

On the map S15, the route preparing function unit 860 further prepares the movement route of a dotted line S28, based on the map S14. The driving wheel 870 moves the moving robot 800 along the movement route of the dotted line S28. Then, in the course of the movement, the obstacle S24 is found, thereby recognizing that the route is blocked.

Here, the route preparing function unit 860 tries the preparation for the movement route based on the map S15. However, there is not the route that enables it to arrive at the destination. So, the obstacle judging function unit 820 extracts the removable obstacle. The removability judging function unit 822 uses the map S12 recorded in the obstacle position recording function unit 821 and the newest map S15 and extracts the obstacle not existing on the map S12 but existing on the map S15. In this example, the obstacle S23 and the obstacle S24 are extracted.

In succession, the person detecting function unit 830 detects the person existing around the moving robot 800. In this example, the person S21 and the person S22 are detected.

Next, the combination selecting function unit 890 determines the combination of the removal target obstacle and the request target person. At first, the obstacle weight obtaining function unit 841 estimates the respective volumes of the obstacle S23 and the obstacle S24 that are extracted by the obstacle judging function unit 820. At the time of this estimation, the shape of the obstacle is assumed to be, for example, a rectangular parallelepiped whose bottom surface exhibits a square. Also, the surface length of the obstacle on the map is assumed to be the length of the one side of the square on the bottom surface. Moreover, under an assumption that the height is uniformly 1 m, the volume of the obstacle is determined.

That is, when the surface length of the obstacle on the map is assumed to be L (an example of a unit, m: meter) and the estimation volume of the obstacle is assumed to be V (an example of a unit, m³: cubic meter), the height is uniformly 1 m. Thus, the following equation (4) is established.

V=L² (4)

Here, when the surface length of the obstacle S24 is assumed to be 1 m and the surface length of the obstacle S23 is assumed to be 1.5 m, the estimation volumes of the obstacles become 1 m³ and 2.25 m³, respectively. Here, moreover, when the densities of the obstacles are assumed to be regularly 1 kg/m³, the weights can be obtained from the estimated volumes. Thus, the weight of the obstacle S24 is estimated to be 1 kg, and the weight of the obstacle S23 is estimated to be 2.25 kg.

On the map S16, the person recognizing function unit 842 recognizes the detected persons and obtains their names of the respective persons. Then, the person age obtaining function unit 844 compares the person name previously recorded in the person age recording function unit 843 and the information of the age of the person and obtains the respective ages of the detected persons. This example is assumed such that the person S21 is 23 years old and the person S22 is 61 yeas old, as indicated on the map S16.

Then, the combination evaluating function unit 845 calculates the weighting work amounts, which correspond to the combinations of the respective obstacle weights and the respective person ages, respectively. The combination evaluating function unit 845 selects the combination of the obstacle and the person that minimizes this weighting work amount, and determines as the combination of the removal target obstacle and the request target person.

Here, a weighting work amount w is defined as represented by the equation (5) under an assumption that a load coefficient determined by the age is: a, and a weight of the obstacle is: m, and a distance that the obstacle is moved is: 1,

w=a×m×l (5)

In this example, as the load coefficient, the inverse number of a relative average gripping power is used which is described in Hiroshi Nagasawa (2003), “Daily Life Activity and Muscular Force”, Physical Therapy Science Vol. 18, No. 1, pp. 7-13, with 20 yeas old as 100%. For example, since the person S21 is 23 yeas old, the relatively average gripping power is 103% and the load coefficient is 0.97. Also, since the person S22 is 61 years old, the relatively average gripping power is 85% and the load coefficient is 1.18. Moreover, the distance when the obstacle is removed is assumed to be, for example, uniformly 1 m.

According to the above description, when the obstacle S24 and the person S21 are selected, the weighting work amount is 0.97 kgfm (KiloGram Force Meter: weight kilogram meter). Similarly, when the obstacle S24 and the person S22 are selected, the weighting work amount is 1.18 kgfm. When the obstacle S23 and the person S21 are selected, the weighting work amount is 2.18 kgfm. When the obstacle S23 and the person S22 are selected, the weighting Z5 work amount is 2.66 kgfm. Thus, the obstacle S24 and the person S21, which minimize the weighting work amount, are determined as the removal target obstacle and the request target person, respectively.

Next, the obstacle movement requesting function unit 850 requests the request target person to remove the removal target obstacle. Specifically, the synthetically speaking function unit 851 requests the request target person selected by the obstacle selecting function unit 840 to remove the removal target obstacle by making a speech. Also, the laser pointer 852 indicates the obstacle to be removed to the person. Moreover, at this time, the head control function unit 853 controls the robot head 854 to be oriented to the direction of the person and nonverbally appeals talking to the request target person.

Finally, when on the map S17, the laser sensor 810 checks the removal of the obstacle, the movement route is again prepared to complete the movement to the target point.

The action effect of this example will be described below.

In this example, when the moving robot tries the movement to the target point and with the interference of the obstacle inside the complicated environment such as the home environment or the like, the movement to the target point is difficult, the person is requested to remove the obstacle. At this time, the work amount is weighted on the basis of the weight of the removable obstacle and the age of the person existing in the periphery, and the combination of the removal target obstacle and the request target person is determined. Thus, in this example, the obstacle and the person can be selected to reduce the cost required for the person when the obstacle is removed.

In this example, the moving robot is the autonomously moving body, in which the above-mentioned first to third exemplary embodiments are properly combined without any technical confliction, having the further additional configuration elements. The autonomously moving bodies according to the first to third exemplary embodiments use the judgment criteria different from each other to select the removal target obstacle. That is, the obstacle removing work amount in the first exemplary embodiment, the movement work amount in the second exemplary embodiment, and the combination of the removal target obstacle and the request target in the third exemplary embodiment are used as the judgment criteria, respectively. The moving robot in this example may select the removal target obstacle by using the comprehensive judgment criteria, such as the application of the proper weighting to the obstacle removing work amount or movement work amount as well as the combination of the removal target obstacle and the request target.

The autonomously moving body and the autonomously moving method of the present invention can be applied as: a moving robot that runs inside a typical home environment or office environment in which an arrangement state of obstacles is complicated; and a moving method used in the moving robot. Also, this can be applied to the field such as an automatically driving system for parking a car in a garage. Moreover, the autonomously moving body in the present invention is not limited to the moving robot that autonomously moves to a target point. For example, this can be applied to even movement control of any robot that is controlled by a remote operation or the like. Moreover, needless to say, this can be applied to, as a moving body, a general vehicle, such as a car, an electric train or the like, which includes an image recognizing function and an intelligence such as an automatic running or the like, a carrying vehicle (carrier) running inside a factory facility or the like, a flying object, a ship, a submarine and the like.

Until now, the three exemplary embodiments and the one example have been described. Each of the moving body, the moving method and the movement control program in the present invention may be designed as the combination of the three exemplary embodiments and the one example without any technical confliction.

Moreover, the autonomously moving method in the respective exemplary embodiments and the example as mentioned above can serve as the autonomous movement control program for controlling the autonomously moving method of the autonomously moving body, when it is made executable by the computer and is stored in a computer-readable recording medium. In this case, this autonomously movement control program can be stored and executed when a proper CPU and memory are installed in the autonomously moving body or autonomously moving robot and then an information processing function is given. Incidentally, each of the function units in the respective exemplary embodiments and example may be attained as the hardware such as a dependent electronic circuit or may be operated as the computer having the CPU and the memory or the jointing action between the hardware and the software such as a part of the program.

The moving body, the moving method and the movement control program of the present invention select the obstacle optimal for the request of the removal from the plurality of obstacles blocking the route of the moving body. This enables the selection of the removal target obstacle so that, for example, the cost required for the request target is reduced, or the cost required for the moving body is reduced, and the cost required for both of them is minimized.

The respective configurations and techniques in the above-mentioned respective exemplary embodiments can be applied to the other exemplary embodiments unless the technical conflict occurs.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2008-007090 filed on Jan. 16, 2008, the disclosure of which is incorporated herein in its entirety by reference.

1-33. (canceled)

34. A moving apparatus comprising:
a route preparing function unit configured to prepare a route to a destination;
a moving function unit configured to move along said route;
an obstacle detecting function unit configured to detect obstacles that interfere in said movement, wherein said route preparing function unit tries to prepare a different route from said route when said obstacles exist on said route, and said moving function unit tries to move to said destination along said different route when said different route exists;
an obstacle removal requesting function unit configured to request an outside to remove said obstacles outside said route when said different route does not exist;
an obstacle judging function unit configured to judge existence of at least one removable obstacle that can be removed from said route among said obstacles detected by said obstacle detecting function unit;
a request target detecting function unit configured to detect at least one request capable target who is capable of being requested to remove said removable obstacle by said obstacle removal requesting function unit, in said outside; and
an obstacle selecting function unit configured to, when said at least one removable obstacle and said at least one request capable target exist, selectively determine a combination of a removal target obstacle that is an obstacle whose removal is requested by said obstacle removal requesting function unit and a request target who is requested to remove said removal target obstacle.

35. The moving apparatus according to claim 34, wherein when there is a plurality of combinations, each of which is a combination of one of said at least one removable obstacle and one of said at least one request capable target, said obstacle selecting function unit selects one combination from said plurality of combinations, said one combination including said removal target obstacle and a request target who is requested to remove said removal target obstacle by said obstacle removal requesting function unit.

36. The moving apparatus according to claim 34, wherein said obstacle selecting function unit selectively determines said combination of said removal target obstacle and said request target so that a cost for said combination is the minimum, by calculating at least one of a cost for a request target a and a cost for said moving apparatus based on at least one of information regarding said obstacle, information regarding said moving apparatus, and information regarding said request target.

37. The moving apparatus according to claim 34, wherein said request target detecting function unit includes:
a person detecting function unit configured to detect a person around said moving apparatus as said at least one request capable target.

38. The moving apparatus according to claim 37, wherein said obstacle removal requesting function unit includes:
a person specifying function unit configured to specify said request target person,
an obstacle specifying function unit configured to specify said removal target obstacle, and
a speaking function unit configured to request removal of said removal target obstacle to said request target person.

39. The moving apparatus according to claim 35, wherein said obstacle selecting function unit includes:
an obstacle removal work amount obtaining function unit configured to obtain a removal work amount for each of said at least one removable obstacle when said request target removes said each of said at least one removable obstacle, and
a removal obstacle removing work amount judging function unit configured to, when there is a plurality of removable obstacles as said at least one removable obstacle, select a removable obstacle whose removal work amount is the smallest in said plurality of removable obstacles,
wherein said removal work amount is calculated based on at least one piece of information included in a volume, a weight, a shape, a length, a surface area, a kind and a distance from said request target, of said removable obstacle.

40. The moving apparatus according to claim 34, wherein said obstacle selecting function unit includes:
a route recording function unit configured to records said route, and
a removal obstacle moving work amount judging function unit configured to select a removable obstacle whose moving work amount to said destination after removal is the smallest, as said removal target obstacle,
wherein said moving work amount is calculated based on at least one piece of information included in a position; a moving route, a kinetic energy, an electric power consumption, a charge remaining amount of electric, a load weight and an operation history of said moving body.

41. The moving apparatus according to claim 39, wherein said obstacle selecting function unit, when said request target is a person, includes:
a person recognizing function unit configured to obtain a name of said detected person,
a person information recording function unit configured to previously record names of persons and information of said persons, and
a combination evaluating function unit configured to selectively determine one combination from combinations of at least one removable obstacle and said detected person based on said removal work amount or said moving work amount and said information of said persons,
wherein said information of said persons includes one of an ID (Identification), an age, a gender, a body height, a schedule and an action history of each of said persons.

42. The moving apparatus according to claim 37, wherein said obstacle selecting function unit includes:
an owner information recording function unit configured to previously record information of owners of said at least one removable obstacle,
an obstacle owner information obtaining function unit configured to obtain information of owners of said at least one removable obstacle from said owner information recording function unit,
a person recognizing function unit configured to recognize a name of said detected person, and
a combination evaluating function unit configured to retrieve a combination that an owner of said at least one removable obstacle and said name of said detected person coincide.

43. The moving apparatus according to claim 37, wherein said name of said detected person is retrieved based on at least one piece of information included in an ID, an age, a gender, a body height, a schedule and an action history, of said detected person.

44. The moving apparatus according to claim 42, wherein said obstacle detecting function unit includes:
a laser sensor configured to detect an object around said moving apparatus by reflection of emitted laser beam,
wherein said obstacle selecting function unit further includes:
a person age recording function unit configured to record an age of a person who is a candidate of said request target, and
a person age obtaining function unit configured to read out an age of said request target person from said person age recording function unit,
wherein said person detecting function unit includes:
a camera configured to make electrical signals corresponding to peripheral landscape, and
a face detecting function unit configured to detect faces of persons from said electrical signals corresponding to said peripheral landscape,
wherein speaking function unit includes:
a synthetically speaking function unit configured to aurally request said request target person to remove said removal target obstacle,
wherein said obstacle specifying function unit includes:
a laser pointer configured to indicate said removal target obstacle by emitting a laser beam,
wherein person specifying function unit includes:
a head unit configured to have a directional character for specifying said request target person, and
a head control function unit configured to control a motion of said head unit,
wherein said moving function unit includes:
two or more driving wheels.

45. A moving method of a moving apparatus, comprising:
(a) a route preparing step of preparing a route to a destination by a route preparing function unit; and
(b) a moving step of trying to move along said route by a moving function unit,
wherein said moving step (b) includes:
(b-1) an obstacle detecting step of trying to detect obstacles by an obstacle detecting function unit,
(b-2) a different route preparing step of trying to prepare a different route from said route by said route preparing function unit, when said obstacles exist on said route in said obstacle detecting step (b-1),
(b-3) a step of trying to move to said destination along said different route by said moving function unit, when said different route exists in said different route preparing step (b-2), and
(b-4) an obstacle removal requesting step of requesting an outside to remove said obstacles outside said route by an obstacle removal requesting function unit, when said different route does not exist in said different route preparing step (b-2),
wherein said obstacle removal requesting step (b-4) includes:
(b-4-a) an obstacle judging step of judging existence of at least one removable obstacle that can be removed from on said route among said obstacles detected by said obstacle detecting function unit, by an obstacle judging function unit,
(b-4-b) a request target detecting step of detecting at least one request capable target who is capable of being requested to remove said removable obstacle, in said outside by a request target detecting function unit, and
(b-4-c) an obstacle selecting step of, when said at least one removable obstacle in said obstacle judging step (b-4-a) and said at least one request capable target in said request target detecting step (b-4-b) exist, selectively determines a removal target obstacle that is an obstacle whose removal is requested by said obstacle removal requesting function unit and a request target who is requested to remove said removal target obstacle by an obstacle selecting function unit.

46. The moving method of a moving apparatus according to claim 45, wherein said obstacle selecting step (b-4-c) includes:
(b-4-c-1) when there is a plurality of combinations, each of which is a combination of one of said at least one removable obstacle in said obstacle judging step (b-4-a) and one of said at least one request capable target in said request target detecting step (b-4-b), a step of selecting one combination from said plurality of combinations, said one combination including said removal target obstacle and a request target who is requested to remove said removal target obstacle by said obstacle removal requesting function unit, by said obstacle selecting function unit.

47. The moving method of a moving apparatus according to claim 45, wherein said obstacle selecting step (b-4-c) includes:
(b-4-c-1a) a step of selectively determining said combination of said removal target obstacle and said request target so that a cost for said combination is the minimum, by calculating at least one of a cost for a request target a and a cost for said moving apparatus based on at least one of information regarding said obstacle, information regarding said moving apparatus, and information regarding said request target by said obstacle selecting function unit.

48. The moving method of a moving apparatus according to claim 45, wherein said request target detecting step (b-4-b) includes:
(b-4-b-1) a request target person detecting step of detecting a person around said moving apparatus as said at least one request capable target by a person detecting function unit.

49. The moving method of a moving apparatus according to claim 48, wherein said obstacle removal requesting step (b-4) includes:
(b-4-d) a person specifying step of specifying said request target person by a person specifying function unit,
(b-4-e) an obstacle specifying step of specifying said removal target obstacle by an obstacle specifying function unit, and
(b-4-f) a speaking step of requesting removal of said removal target obstacle to said request target person by a speaking function unit.

50. The moving method of a moving apparatus according to claim 46, wherein said obstacle selecting step (b-4-c) includes:
(b-4-c-2) an obstacle removal work amount obtaining step of obtaining a removal work amount for each of said at least one removable obstacle when said request target removes said each of said at least one removable obstacle by an obstacle removal work amount obtaining function unit, and
(b-4-c-3) a step of, when there is a plurality of removable obstacles as said at least one removable obstacle, selecting a removable obstacle whose removal work amount is the smallest in said plurality of removable obstacles by a removal obstacle removing work amount judging function unit,
wherein said removal work amount is calculated based on at least one piece of information included in a volume, a weight, a shape, a length, a surface area, a kind and a distance from said request target, of said removable obstacle.

51. The moving method of a moving apparatus according to claim 45, wherein said route preparing step (a) includes:
(a-1) a route recording step of configured to records said route by a route recording function unit,
wherein said obstacle selecting step (b-4-c) includes:
(b-4-c-4) a removal obstacle judging step of selecting a removable obstacle that exists on a route whose route length to said destination is the smallest, as said removal target obstacle by a removal obstacle moving work amount judging function unit,
wherein said moving work amount is calculated based on at least one piece of information included in a position, a moving route, a kinetic energy, an electric power consumption, a charge remaining amount of electric, a load weight and an operation history of said moving body.

52. The moving method of a moving apparatus according to claim 50, wherein said obstacle selecting step (b-4-c), when said request target is a person, includes:
(b-4-c-5) a step of previously recording names of persons and information of said persons by a person information recording function unit,
(b-4-c-6) a person recognizing step of obtaining a name of said detected person by a person recognizing function unit, and
(b-4-c-7) a combination evaluating step of selectively determining one combination from combinations of at least one removable obstacle and said detected person based on said removal work amount or said moving work amount and said information of said persons by a combination evaluating function unit,
wherein said information of said persons includes one of an ID (Identification), an age, a gender, a body height, a schedule and an action history of each of said persons.

53. The moving method of a moving apparatus according to claim 48, wherein said obstacle selecting step (b-4-c) includes:
(b-4-c-8) an obstacle owner information obtaining step of obtaining information of owners of said at least one removable obstacle from an owner information recording function unit by an obstacle owner information obtaining function unit,
(b-4-c-9) a person recognizing step of obtaining a name of said detected person by a person recognizing function unit,
(b-4-c-10) a combination evaluating step of retrieving a combination that an owner of said at least one removable obstacle and said name of said detected person coincide by a combination evaluating function unit, and
(b-4-c-11) a step of stopping said movement when said combination that said owner of said at least one removable obstacle and said name of said detected person coincide does not exist.

54. The moving method of a moving apparatus according to claim 48, wherein said name of said detected person is obtained based on at least one piece of information included in an ID, an age, a gender, a body height, a schedule and an action history, of said detected person.

55. The moving method of a moving apparatus according to claim 53, wherein said obstacle judging step (b-4-a) includes:
(b-4-a-2) a step of stopping said movement when an obstacle that can be removed does not exist on said route,
wherein said request target detecting step (b-4-b) includes:
(b-4-b-2) a step of stopping said movement when said person does not exist around said moving body.

56. A movement control program of a moving apparatus, which is computer-readable and operable to control a computer to perform a moving method of a moving apparatus, said moving method comprising:
(a) a route preparing step of preparing a route to a destination by a route preparing function unit; and
(b) a moving step of trying to move along said route by a moving function unit, wherein said moving step (b) includes:
(b-1) an obstacle detecting step of trying to detect obstacles by an obstacle detecting function unit,
(b-2) a different route preparing step of trying to prepare a different route from said route by said route preparing function unit, when said obstacles exist on said route in said obstacle detecting step (b-1),
(b-3) a step of trying to move to said destination along said different route by said moving function unit, when said different route exists in said different route preparing step (b-2), and
(b-4) an obstacle removal requesting step of requesting an outside to remove said obstacles outside said route by an obstacle removal requesting function unit, when said different route does not exist in said different route preparing step (b-2),
wherein said obstacle removal requesting step (b-4) includes:
(b-4-a) an obstacle judging step of judging existence of at least one removable obstacle that can be removed from on said route among said obstacles detected by said obstacle detecting function unit, by an obstacle judging function unit,
(b-4-b) a request target detecting step of detecting at least one request capable target who is capable of being requested to remove said removable obstacle, in said outside by a request target detecting function unit, and
(b-4-c) an obstacle selecting step of, when said at least one removable obstacle in said obstacle judging step (b-4-a) and said at least one request capable target in said request target detecting step (b-4-b) exist, selectively determines a removal target obstacle that is an obstacle whose removal is requested by said obstacle removal requesting function unit and a request target who is requested to remove said removal target obstacle by an obstacle selecting function unit.

57. The movement control program of a moving apparatus according to claim 56, in said moving method, wherein said obstacle selecting step (b-4-c) includes:
(b-4-c-1) when there is a plurality of combinations, each of which is a combination of one of said at least one removable obstacle in said obstacle judging step (b-4-a) and one of said at least one request capable target in said request target detecting step (b-4-b), a step of selecting one combination from said plurality of combinations, said one combination including said removal target obstacle and a request target who is requested to remove said removal target obstacle by said obstacle removal requesting function unit, by said obstacle selecting function unit.

58. The movement control program of a moving apparatus according to claim 56, in said moving method, wherein said obstacle selecting step (b-4-c) includes:
(b-4-c-1a) a step of selectively determining said combination of said removal target obstacle and said request target so that a cost for said combination is the minimum, by calculating at least one of a cost for a request target a and a cost for said moving apparatus based on at least one of information regarding said obstacle, information regarding said moving apparatus, and information regarding said request target by said obstacle selecting function unit.

59. The movement control program of a moving apparatus according to claim 56, in said moving method, wherein said request target detecting step (b-4-b) includes:
(b-4-b-1) a request target person detecting step of detecting a person around said moving apparatus as said at least one request capable target by a person detecting function unit.

60. The movement control program of a moving apparatus according to claim 59, in said moving method, wherein said obstacle removal requesting step (b-4) includes:
(b-4-d) a person specifying step of specifying said request target person by a person specifying function unit,
(b-4-e) an obstacle specifying step of specifying said removal target obstacle by an obstacle specifying function unit, and
(b-4-f) a speaking step of requesting removal of said removal target obstacle to said request target person by a speaking function unit.

61. The movement control program of a moving apparatus according to claim 56, in said moving method, wherein said obstacle selecting step (b-4-c) includes:
(b-4-c-2) an obstacle removal work amount obtaining step of obtaining a removal work amount for each of said at least one removable obstacle when said request target removes said each of said at least one removable obstacle by an obstacle removal work amount obtaining function unit, and
(b-4-c-3) a step of, when there is a plurality of removable obstacles as said at least one removable obstacle, selecting a removable obstacle whose removal work amount is the smallest in said plurality of removable obstacles by a removal obstacle removing work amount judging function unit,
wherein said removal work amount is calculated based on at least one piece of information included in a volume, a weight, a shape, a length, a surface area, a kind and a distance from said request target, of said removable obstacle.

62. The movement control program of a moving apparatus according to claim 56, in said moving method, wherein said route preparing step (a) includes:
(a-1) a route recording step of configured to records said route by a route recording function unit,
wherein said obstacle selecting step (b-4-c) includes:
(b-4-c-4) a removal obstacle judging step of selecting a removable obstacle that exists on a route whose route length to said destination is the smallest, as said removal target obstacle by a removal obstacle moving work amount judging function unit,
wherein said moving work amount is calculated based on at least one piece of information included in a position, a moving route, a kinetic energy, an electric power consumption, a charge remaining amount of electric, a load weight and an operation history of said moving body.

63. The movement control program of a moving apparatus according to claim 61, in said moving method, wherein said obstacle selecting step (b-4-c), when said request target is a person, includes:
(b-4-c-5) a step of previously recording names of persons and information of said persons by a person information recording function unit,
(b-4-c-6) a person recognizing step of obtaining a name of said detected person by a person recognizing function unit, and
(b-4-c-7) a combination evaluating step of selectively determining one combination from combinations of at least one removable obstacle and said detected person based on said removal work amount or said moving work amount and said information of said persons by a combination evaluating function unit,
wherein said information of said persons includes one of an ID (Identification), an age, a gender, a body height, a schedule and an action history of each of said persons.

64. The movement control program of a moving apparatus according to claim 59, in said moving method, wherein said obstacle selecting step (b-4-c) includes:
(b-4-c-8) an obstacle owner information obtaining step of obtaining information of owners of said at least one removable obstacle from an owner information recording function unit by an obstacle owner information obtaining function unit,
(b-4-c-9) a person recognizing step of obtaining a name of said detected person by a person recognizing function unit,
(b-4-c-10) a combination evaluating step of retrieving a combination that an owner of said at least one removable obstacle and said name of said detected person coincide by a combination evaluating function unit, and
(b-4-c-11) a step of stopping said movement when said combination that said owner of said at least one removable obstacle and said name of said detected person coincide does not exist.

65. The movement control program of a moving apparatus according to claim 59, in said moving method, wherein said name of said detected person is obtained based on at least one piece of information included in an ID, an age, a gender, a body height, a schedule and an action history, of said detected person.

66. The movement control program of a moving apparatus according to claim 64, in said moving method, wherein said obstacle judging step (b-4-a) includes:
(b-4-a-2) a step of stopping said movement when an obstacle that can be removed does not exist on said route,
wherein said request target detecting step (b-4-b) includes:
(b-4-b-2) a step of stopping said movement when said person does not exist around said moving body.
